(19) United States
(12) Patent Application Publication
(10) Pub. No.: US 2016/0157271 A1
(43) Pub. Date: Jun. 2, 2016

(54) Method for Randomly Accessing Network, Terminal, and Base Station

(71) Applicant: Huawei Technologies Co., Ltd., Shenzhen (CN)

(72) Inventors: Xiangdong Zhang, Beijing (CN); Zheng Yu, Beijing (CN); Fang Nan, Beijing (CN)

(21) Appl. No.: 15/017,146

(22) Filed: Feb. 5, 2016

Related U.S. Application Data
(63) Continuation of application No. PCT/CN2013/081471, filed on Aug. 14, 2013.

(51) Int. Cl. H04W 74/08; H04W 4/00

(52) U.S. Cl. CPC H04W 74/0833; H04W 4/005

(57) ABSTRACT

A method for randomly accessing a network, a terminal, and a base station where the method includes acquiring, by a machine type communication (MTC) terminal, predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and initiating, by the MTC terminal, a random access process using the acquired predefined random access resources, and when the random access resources corresponding to the MTC terminal are insufficient, the MTC terminal initiates the random access process using the acquired predefined random access resources, such that a probability that a conflict occurs in randomly accessing a network is reduced, and random access resource utilization is improved.

### CROSS-REFERENCE TO RELATED APPLICATIONS

This application is a continuation of International Application No. PCT/CN2013/081471, filed on Aug. 14, 2013, which is hereby incorporated by reference in its entirety.

### TECHNICAL FIELD

The present disclosure relates to the field of the Internet of Things, and in particular, to a method for randomly accessing a network, a terminal, and a base station.

### BACKGROUND

In a network of the Internet of Things, one base station serves multiple machine type communication (MTC) terminals at the same time. For an MTC terminal in a particular environment, such as an electricity meter or a water meter that is placed in a basement, a coverage enhancement technology needs to be used, such that the MTC device can complete communication with a system. Before an MTC terminal communicates with a base station, the MTC terminal needs to access a network by means of a random access process.

In the prior art, for a device that requires coverage enhancement, a method for randomly accessing a network is provided and may be as follows: A base station groups random access resources according to coverage enhancement levels, for example, allocates the random access resources evenly to each coverage enhancement level, and sends a notification message to all MTC terminals for which the base station provides a service, where the notification message carries a correspondence between a coverage enhancement level and a random access resource group. An MTC terminal receives the notification message sent by the base station, and determines a coverage enhancement level according to its own path loss, acquires, from the correspondence between a coverage enhancement level and a random access resource group, a random access resource group and a corresponding random access resource according to the determined coverage enhancement level, and initiates, by using the acquired random access resource, a random access process to access a network.

In a process of implementing the present disclosure, the inventor finds that the prior art has at least the following problems:

When a base station has not obtained information about an MTC terminal served by the base station, or after a period of time since the base station obtained information about an MTC terminal served by the base station and grouped random access resources according to coverage enhancement levels, the base station may be not capable or no longer capable of providing a good access service for the MTC terminal using the random access resources grouped according to the coverage enhancement levels. For example, within a period of time, if there are too many MTC terminals at a coverage enhancement level, random access resources that are included in a random access resource group corresponding to the coverage enhancement level are relatively insufficient, resulting in a higher probability that a conflict occurs in randomly accessing a network, while there are fewer MTC terminals at another coverage enhancement level, and random access resources that are included in a random access resource group corresponding to the coverage enhancement level are relatively sufficient, resulting in low random access resource utilization.

### SUMMARY

To resolve the problem in the prior art, the present disclosure provides a method for randomly accessing a network, a terminal, and a base station. The technical solutions are as follows:

According to a first aspect, the present disclosure provides a method for randomly accessing a network, where the method includes: acquiring, by a MTC terminal, predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and initiating, by the MTC terminal, a random access process using the acquired predefined random access resources.

With reference to the first aspect, in a first possible implementation manner of the first aspect, the MTC terminal is a terminal that requires coverage enhancement, and before the acquiring, by a machine type communication MTC terminal, predefined random access resources when random access resources corresponding to the MTC terminal are insufficient, the method further includes determining, by the MTC terminal, a coverage enhancement level of the MTC terminal, acquiring, according to the coverage enhancement level of the MTC terminal, random access resources corresponding to the coverage enhancement level of the MTC terminal, and using the random access resources corresponding to the coverage enhancement level of the MTC terminal, as the random access resources corresponding to the MTC terminal.

With reference to the first possible implementation manner of the first aspect, in a second possible implementation manner of the first aspect, the random access resources include a (TF-resource) and a preamble resource, and correspondingly, the acquiring predefined random access resources includes acquiring a TF-resource in predefined TF-resources and a preamble that is included in a preamble resource group in the random access resources corresponding to the coverage enhancement level of the MTC terminal.

With reference to the second possible implementation manner of the first aspect, in a third possible implementation manner of the first aspect, the initiating, by the MTC terminal, a random access process using the acquired predefined random access resources includes sending, by the MTC terminal, the acquired preamble to a base station over the acquired predefined TF-resource, in order to notify the base station that the random access resources corresponding to the coverage enhancement level of the MTC terminal are insufficient.

With reference to the first possible implementation manner of the first aspect, in a fourth possible implementation manner of the first aspect, the random access resources include a TF-resource and a preamble resource, and correspondingly, the acquiring predefined random access resources includes, acquiring, by the MTC terminal, a predefined TF-resource in the TF-resources in the random access resources corresponding to the coverage enhancement level of the MTC terminal, and acquiring a predefined preamble that is included in a preamble resource group in the random access resources corresponding to the coverage enhancement level of the MTC terminal.

With reference to the fourth possible implementation manner of the first aspect, in a fifth possible implementation manner of the first aspect, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

With reference to the first possible implementation manner of the first aspect, in a sixth possible implementation manner of the first aspect, the random access resources include a TF-resource and a preamble resource, and correspondingly, the acquiring predefined random access resources includes, acquiring a preamble in predefined preamble resources and a TF-resource that is included in a TF-resource group in the random access resources corresponding to the coverage enhancement level of the MTC terminal.

With reference to the sixth possible implementation manner of the first aspect, in a seventh possible implementation manner of the first aspect, the initiating, by the MTC terminal, a random access process using the acquired predefined random access resources includes: sending, by the MTC terminal, the acquired preamble in the predefined preamble resources to a base station over the acquired TF-resource, in order to notify the base station that the random access resources corresponding to the coverage enhancement level of the MTC terminal are insufficient.

With reference to the first possible implementation manner of the first aspect, in an eighth possible implementation manner of the first aspect, the random access resources include a TF-resource and a preamble resource, and correspondingly, the acquiring predefined random access resources includes acquiring a predefined preamble in the preamble resources in the random access resources corresponding to the coverage enhancement level of the MTC terminal, and acquiring a predefined TF-resource that is included in a TF-resource group in the random access resources corresponding to the coverage enhancement level of the MTC terminal.

With reference to the eighth possible implementation manner of the first aspect, in a ninth possible implementation manner of the first aspect, the initiating, by the MTC terminal, a random access process using the acquired predefined random access resources includes: sending, by the MTC terminal, the acquired predefined preamble in the preamble resources corresponding to the MTC terminal to a base station over the acquired predefined TF-resource, in order to notify the base station that the random access resources corresponding to the coverage enhancement level of the MTC terminal are insufficient.

With reference to the first possible implementation manner of the first aspect, in a tenth possible implementation manner of the first aspect, the random access resources include a TF-resource and a preamble resource, and correspondingly, the acquiring predefined random access resources includes acquiring a predefined TF-resource that is included in a TF-resource group in the random access resources corresponding to the coverage enhancement level of the MTC terminal, and a predefined preamble that is included in a preamble resource group in the random access resources corresponding to the coverage enhancement level of the MTC terminal.

With reference to the tenth possible implementation manner of the first aspect, in an eleventh possible implementation manner of the first aspect, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

With reference to the first possible implementation manner of the first aspect, in a twelfth possible implementation manner of the first aspect, the random access resources include a TF-resource and a preamble resource, and correspondingly, the acquiring predefined random access resources includes acquiring a preamble except the random access resources corresponding to the coverage enhancement level of the MTC terminal, and a predefined TF-resource that is included in a TF-resource group in the random access resources corresponding to the coverage enhancement level of the MTC terminal.

With reference to the twelfth possible implementation manner of the first aspect, in a thirteenth possible implementation manner of the first aspect, the initiating, by the MTC terminal, a random access process using the acquired predefined random access resources includes sending, by the MTC terminal, the acquired preamble to a base station over the acquired predefined TF-resource, in order to notify the base station that the random access resources corresponding to the coverage enhancement level of the MTC terminal are insufficient.

With reference to the first possible implementation manner of the first aspect, in a fourteenth possible implementation manner of the first aspect, the random access resources include a TF-resource and a preamble resource, and correspondingly, the acquiring predefined random access resources includes acquiring a TF-resource except the random access resources corresponding to the coverage enhancement level of the MTC terminal, and a predefined preamble that is included in a preamble resource group in the random access resources corresponding to the coverage enhancement level of the MTC terminal.

With reference to the fourteenth possible implementation manner of the first aspect, in a fifteenth possible implementation manner of the first aspect, the initiating, by the MTC terminal, a random access process using the acquired predefined random access resources includes sending, by the MTC terminal, the acquired predefined preamble to a base station over the acquired TF-resource, in order to notify the base station that the random access resources corresponding to the coverage enhancement level of the MTC terminal are insufficient.

With reference to the first possible implementation manner of the first aspect, in a sixteenth possible implementation manner of the first aspect, the random access resources include a TF-resource and a preamble resource, and correspondingly, the acquiring predefined random access resources includes, acquiring a predefined TF-resource except the random access resources corresponding to the coverage enhancement level of the MTC terminal, and a predefined preamble except the random access resources corresponding to the coverage enhancement level of the MTC terminal.

With reference to the sixteenth possible implementation manner of the first aspect, in a seventeenth possible implementation manner of the first aspect, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

With reference to the first possible implementation manner of the first aspect, in an eighteenth possible implementation manner of the first aspect, the acquiring predefined random access resources includes acquiring, by the MTC terminal, a coverage enhancement level except the coverage enhancement level of the MTC terminal, and acquiring the predefined random access resources according to the acquired coverage enhancement level except the coverage enhancement level of the MTC terminal.

With reference to the eighteenth possible implementation manner of the first aspect, in a nineteenth possible implementation manner of the first aspect, the random access resources include a TF-resource and a preamble resource, and correspondingly, the acquiring the predefined random access resources according to the acquired coverage enhancement level except the coverage enhancement level of the MTC terminal includes acquiring, by the MTC terminal, a TF-resource and a preamble that are in random access resources corresponding to the coverage enhancement level except the coverage enhancement level of the MTC terminal.

With reference to the nineteenth possible implementation manner of the first aspect, in a twentieth possible implementation manner of the first aspect, the initiating, by the MTC terminal, a random access process using the acquired predefined random access resources includes: sending, by the MTC terminal, the preamble in the random access resources corresponding to the coverage enhancement level except the coverage enhancement level of the MTC terminal, to a base station over the TF-resource in the random access resources corresponding to the coverage enhancement level except the coverage enhancement level of the MTC terminal, in order to initiate the random access process.

With reference to the eighteenth possible implementation manner of the first aspect, in a twenty-first possible implementation manner of the first aspect, the random access resources include a TF-resource and a preamble resource, and correspondingly, the acquiring the predefined random access resources according to the coverage enhancement level except the coverage enhancement level of the MTC terminal includes: acquiring, by the MTC terminal, a TF-resource in random access resources corresponding to the coverage enhancement level except the coverage enhancement level of the MTC terminal, and acquiring, by the MTC terminal, a preamble in the preamble resources in the random access resources corresponding to the coverage enhancement level of the MTC terminal.

With reference to the twenty-first possible implementation manner of the first aspect, in a twenty-second possible implementation manner of the first aspect, the initiating, by the MTC terminal, a random access process using the acquired predefined random access resources includes: sending the preamble in the preamble resources in the random access resources corresponding to the coverage enhancement level of the MTC terminal, to a base station over the TF-resource in the random access resources corresponding to the coverage enhancement level except the coverage enhancement level of the MTC terminal, in order to initiate the random access process.

With reference to the eighteenth possible implementation manner of the first aspect, in a twenty-third possible implementation manner of the first aspect, the random access resources include a TF-resource and a preamble resource, and correspondingly, the acquiring the predefined random access resources according to the coverage enhancement level except the coverage enhancement level of the MTC terminal includes: acquiring, by the MTC terminal, a preamble resource in random access resources corresponding to the coverage enhancement level except the coverage enhancement level of the MTC terminal, and acquiring, by the MTC terminal, a TF-resource in the TF-resources in the random access resources corresponding to the coverage enhancement level of the MTC terminal.

With reference to the twenty-third possible implementation manner of the first aspect, in a twenty-fourth possible implementation manner of the first aspect, the initiating, by the MTC terminal, a random access process using the acquired predefined random access resources includes: sending the preamble resource in the random access resources corresponding to the coverage enhancement level except the coverage enhancement level of the MTC terminal, to a base station over the TF-resource in the TF-resources in the random access resources corresponding to the coverage enhancement level of the MTC terminal, in order to initiate the random access process.

With reference to the eighteenth possible implementation manner of the first aspect, in a twenty-fifth possible implementation manner of the first aspect, the random access resources include a TF-resource and a preamble resource, and correspondingly, the acquiring the predefined random access resources according to the coverage enhancement level except the coverage enhancement level of the MTC terminal includes, acquiring, by the MTC terminal, a TF-resource in random access resources corresponding to the coverage enhancement level except the coverage enhancement level of the MTC terminal, and acquiring, by the MTC terminal, a preamble that is included in a preamble resource group in the random access resources corresponding to the coverage enhancement level of the MTC terminal.

With reference to the twenty-fifth possible implementation manner of the first aspect, in a twenty-sixth possible implementation manner of the first aspect, the initiating, by the MTC terminal, a random access process using the acquired predefined random access resources includes: sending the preamble to a base station over the acquired TF-resource, in order to initiate the random access process.

With reference to the twentieth, the twenty-second, the twenty-fourth, or the twenty-sixth possible implementation manner of the first aspect, in a twenty-seventh possible implementation manner of the first aspect, the method further includes notifying the base station that the random access resources corresponding to the coverage enhancement level of the MTC terminal are insufficient.

With reference to the eighteenth possible implementation manner of the first aspect, in a twenty-eighth possible implementation manner of the first aspect, the random access resources include a TF-resource and a preamble resource, and correspondingly, the initiating, by the MTC terminal, a random access process using the acquired predefined random access resources includes, acquiring, by the MTC terminal according to the coverage enhancement level of the MTC terminal and/or the coverage enhancement level except the coverage enhancement level of the MTC terminal, power at which the MTC terminal sends a preamble, and sending the acquired preamble to a base station over the acquired TF-resource at the acquired power for sending the preamble, in order to initiate the random access process.

With reference to the first possible implementation manner of the first aspect, in a twenty-ninth possible implementation manner of the first aspect, after the initiating, by the MTC terminal, a random access process using the acquired predefined random access resources, the method further includes receiving, by the MTC terminal, a response random access response (RAR) message sent by a base station, and sending a random access process message 3 to the base station according to the RAR message, where the random access process message 3 carries coverage enhancement level information of the MTC terminal.

With reference to the twenty-ninth possible implementation manner of the first aspect, in a thirtieth possible implementation manner of the first aspect, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

With reference to the first aspect, in a thirty-first possible implementation manner of the first aspect, before the acquiring, by an MTC terminal, predefined random access resources, the method further includes: receiving configuration information sent by a base station, where the configuration information carries identifiers of the predefined random access resources.

According to a second aspect, the present disclosure provides a method for randomly accessing a network, where the method includes: sending, by a base station, configuration information to an MTC terminal, where the configuration information carries identifiers of predefined random access resources, such that the MTC terminal acquires the predefined random access resources according to the configuration information, and accepting, by the base station, a random access process that is initiated by the MTC terminal using the acquired predefined random access resources.

With reference to the second aspect, in a first possible implementation manner of the second aspect, the accepting, by the base station, a random access process that is initiated by the MTC terminal using the acquired predefined random access resources includes: determining, by the base station according to the random access process that is initiated by the MTC terminal over the predefined random access resources, that random access resources corresponding to the MTC terminal are insufficient.

With reference to the first possible implementation manner of the second aspect, in a second possible implementation manner of the second aspect, the MTC terminal is a terminal that requires coverage enhancement, and correspondingly, the determining, by the base station according to the random access process that is initiated by the MTC terminal over the predefined random access resources, that random access resources corresponding to the MTC terminal are insufficient includes: determining, by the base station according to the predefined random access resources, that random access resources corresponding to a coverage enhancement level of the MTC terminal are insufficient.

With reference to the second aspect, in a third possible implementation manner of the second aspect, the MTC terminal is a terminal that requires coverage enhancement, and correspondingly, the accepting, by the base station, a random access process that is initiated by the MTC terminal using the acquired predefined random access resources includes: sending, by the base station, a response RAR message to the MTC terminal, such that the MTC terminal sends a message 3 to the base station according to the RAR message, and receiving the message 3 sent by the MTC terminal, where the message 3 carries coverage enhancement level information of the MTC terminal.

With reference to the third possible implementation manner of the second aspect, in a fourth possible implementation manner of the second aspect, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

With reference to the second or the third possible implementation manner of the second aspect, in a fifth possible implementation manner of the second aspect, the method further includes: determining, by the base station, the coverage enhancement level of the MTC terminal.

With reference to the fifth possible implementation manner of the second aspect, in a sixth possible implementation manner of the second aspect, the determining, by the base station, the coverage enhancement level of the MTC terminal includes: determining, by the base station according to the predefined random access resources and/or the message 3, the coverage enhancement level of the MTC terminal.

With reference to the fifth possible implementation manner of the second aspect, in a seventh possible implementation manner of the second aspect, after the determining, by the base station according to the predefined random access resources, that random access resources corresponding to a coverage enhancement level of the MTC terminal are insufficient, and the determining, by the base station, the coverage enhancement level of the MTC terminal, the method further includes increasing, by the base station, the random access resources corresponding to the coverage enhancement level of the MTC terminal.

With reference to the seventh possible implementation manner of the second aspect, in an eighth possible implementation manner of the second aspect, the random access resources include a TF-resource and a preamble resource, and correspondingly, the increasing, by the base station, the random access resources corresponding to the coverage enhancement level of the MTC terminal includes: acquiring a first predefined quantity of TF-resources from a TF-resource group in random access resources corresponding to a coverage enhancement level except the coverage enhancement level of the MTC terminal, or acquiring a second predefined quantity of TF-resources from TF-resources in random access resources corresponding to a coverage enhancement level except the coverage enhancement level of the MTC terminal, or acquiring a third predefined quantity of TF-resources from TF-resources except random access resources corresponding to all coverage enhancement levels in the base station, and transferring the acquired first predefined quantity of TF-resources, or the acquired second predefined quantity of TF-resources, or the acquired third predefined quantity of TF-resources to the random access resources corresponding to the coverage enhancement level of the MTC terminal, where the first predefined quantity is less than or equal to a quantity of TF-resources that are included in the TF-resource group, the second predefined quantity is less than or equal to a quantity of TF-resources that are included in the TF-resources, and the third predefined quantity is less than or equal to a quantity of TF-resources that are included in the TF-resources except the random access resources corresponding to all the coverage enhancement levels in the base station.

With reference to the seventh possible implementation manner of the second aspect, in a ninth possible implementation manner of the second aspect, the random access resources include a TF- resource and a preamble resource, and correspondingly, the increasing, by the base station, the random access resources corresponding to the coverage enhancement level of the MTC terminal includes acquiring a fourth predefined quantity of preambles from a preamble resource group in random access resources corresponding to a coverage enhancement level except the coverage enhancement level of the MTC terminal, or acquiring a fifth predefined quantity of preambles from preamble resources in random access resources corresponding to a coverage enhancement level except the coverage enhancement level of the MTC terminal, or acquiring a sixth predefined quantity of preambles from preamble resources except random access resources corresponding to all coverage enhancement levels in the base station, and transferring the acquired fourth predefined quantity of preambles, or the acquired fifth predefined quantity of preambles, or the acquired sixth predefined quantity of preambles to the random access resources corresponding to the coverage enhancement level of the MTC terminal, where the fourth predefined quantity is less than or equal to a quantity of preambles that are included in the preamble resource group, the fifth predefined quantity is less than or equal to a quantity of preambles that are included in the preamble resources, and the sixth predefined quantity is less than or equal to a quantity of preambles that are included in the preamble resources except the random access resources corresponding to all the coverage enhancement levels in the base station.

With reference to the seventh possible implementation manner of the second aspect, in a tenth possible implementation manner of the second aspect, the random access resources include a TF-resource and a preamble resource, and correspondingly, the increasing, by the base station, the random access resources corresponding to the coverage enhancement level of the MTC terminal includes acquiring a seventh predefined quantity of TF-resources and an eighth predefined quantity of preambles respectively from a TF-resource group and a preamble resource group that are in random access resources corresponding to a coverage enhancement level except the coverage enhancement level of the MTC terminal, and transferring the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group, or acquiring a ninth predefined quantity of TF-resources and a tenth predefined quantity of preambles respectively from TF-resources and preamble resources that are in random access resources corresponding to a coverage enhancement level except the coverage enhancement level of the MTC terminal, and transferring the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources, or acquiring an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transferring the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

With reference to the fifth possible implementation manner of the second aspect, in an eleventh possible implementation manner of the second aspect, the determining, by the base station according to the predefined random access resources, that random access resources corresponding to a coverage enhancement level of the MTC terminal are insufficient includes: receiving, by the base station, a preamble that is included in a preamble resource group in the random access resources corresponding to the coverage enhancement level of the MTC terminal and that is sent by the MTC terminal over a TF-resource in predefined TF-resources, and determining that the random access resources corresponding to the coverage enhancement level of the MTC terminal are insufficient.

With reference to the fifth possible implementation manner of the second aspect, in a twelfth possible implementation manner of the second aspect, the determining, by the base station according to the predefined random access resources, that random access resources corresponding to a coverage enhancement level of the MTC terminal are insufficient includes receiving, by the base station, a predefined preamble that is included in a preamble resource group in the random access resources corresponding to the coverage enhancement level of the MTC terminal, and that is sent by the MTC terminal over a predefined TF-resource in TF-resources in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a thirteenth possible implementation manner of the second aspect, the determining, by the base station according to the predefined random access resources, that random access resources corresponding to a coverage enhancement level of the MTC terminal are insufficient includes receiving, by the base station, a preamble that is in predefined preamble resources and is sent by the MTC terminal over a TF-resource that is included in a TF-resource group in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a fourteenth possible implementation manner of the second aspect, the determining, by the base station according to the predefined random access resources, that random access resources corresponding to a coverage enhancement level of the MTC terminal are insufficient includes: receiving, by the base station, a predefined preamble that is in preamble resources in the random access resources corresponding to the coverage enhancement level of the MTC terminal, and that is sent by the MTC terminal over a predefined TF-resource that is included in a TF-resource group in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a fifteenth possible implementation manner of the second aspect, the determining, by the base station according to the predefined random access resources, that random access resources corresponding to a coverage enhancement level of the MTC terminal are insufficient includes: receiving, by the base station, a predefined preamble that is included in a preamble resource group and is sent by the MTC terminal over a predefined TF-resource that is included in a TF-resource group in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a sixteenth possible implementation manner of the second aspect, the determining, by the base station according to the predefined random access resources, that random access resources corresponding to a coverage enhancement level of the MTC terminal are insufficient includes receiving, by the base station, a preamble, except the random access resources corresponding to the coverage enhancement level of the MTC terminal, that is sent by the MTC terminal over a predefined TF-resource that is included in a TF-resource group in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a seventeenth possible implementation manner of the second aspect, the determining, by the base station according to the predefined random access resources, that random access resources corresponding to a coverage enhancement level of the MTC terminal are insufficient includes: receiving, by the base station, a predefined preamble that is included in a preamble resource group in the random access resources corresponding to the coverage enhancement level of the MTC terminal, and that is sent by the MTC terminal over a TF-resource except the random access resources corresponding to the coverage enhancement level of the MTC terminal, and determining that the random access resources corresponding to the coverage enhancement level of the MTC terminal are insufficient.

With reference to the fifth possible implementation manner of the second aspect, in an eighteenth possible implementation manner of the second aspect, the determining, by the base station according to the predefined random access resources, that random access resources corresponding to a coverage enhancement level of the MTC terminal are insufficient includes receiving, by the base station, a predefined preamble, except the random access resources corresponding to the coverage enhancement level of the MTC terminal, that is sent by the MTC terminal over a predefined TF-resource except the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a nineteenth possible implementation manner of the second aspect, the determining, by the base station according to the predefined random access resources, that random access resources corresponding to a coverage enhancement level of the MTC terminal are insufficient includes receiving, by the base station, a preamble that is in random access resources corresponding to a coverage enhancement level except the coverage enhancement level of the MTC terminal, and that is sent by the MTC terminal over a TF-resource in the random access resources corresponding to the coverage enhancement level except the coverage enhancement level of the MTC terminal, and determining that the random access resources corresponding to the coverage enhancement level of the MTC terminal are insufficient.

With reference to the fifth possible implementation manner of the second aspect, in a twentieth possible implementation manner of the second aspect, the determining, by the base station according to the predefined random access resources, that random access resources corresponding to a coverage enhancement level of the MTC terminal are insufficient includes receiving, by the base station, a preamble resource that is in random access resources corresponding to a coverage enhancement level except the coverage enhancement level of the MTC terminal, and that is sent by the MTC terminal over a TF-resource in TF-resources in the random access resources corresponding to the coverage enhancement level of the MTC terminal, and determining that the random access resources corresponding to the coverage enhancement level of the MTC terminal are insufficient.

With reference to the fifth possible implementation manner of the second aspect, in a twenty-first possible implementation manner of the second aspect, the determining, by the base station according to the predefined random access resources, that random access resources corresponding to a coverage enhancement level of the MTC terminal are insufficient includes receiving, by the base station, a preamble that is included in a preamble resource group in the random access resources corresponding to the coverage enhancement level of the MTC terminal, and that is sent by the MTC terminal over a TF-resource in random access resources corresponding to a coverage enhancement level except the coverage enhancement level of the MTC terminal, and determining that the random access resources corresponding to the coverage enhancement level of the MTC terminal are insufficient.

According to a third aspect, the present disclosure provides a terminal, where the terminal includes an acquiring module configured to acquire predefined random access resources when random access resources corresponding to a machine type communication MTC terminal are insufficient, where the predefined random access resources are random access resources corresponding to the MTC terminal, or the predefined random access resources are random access resources except random access resources corresponding to the MTC terminal, and an access module configured to initiate a random access process using the acquired predefined random access resources.

With reference to the third aspect, in a first possible implementation manner of the third aspect, the terminal further includes a first determining module configured to determine a coverage enhancement level of the MTC terminal, where the acquiring module is further configured to acquire, according to the coverage enhancement level of the MTC terminal, random access resources corresponding to the coverage enhancement level of the MTC terminal, and use the random access resources corresponding to the coverage enhancement level of the MTC terminal, as the random access resources corresponding to the MTC terminal.

With reference to the first possible implementation manner of the third aspect, in a second possible implementation manner of the third aspect, the random access resources include a TF-resource and a preamble resource, and correspondingly, the acquiring module is configured to acquire a TF-resource in predefined TF-resources and a preamble that is included in a preamble resource group in the random access resources corresponding to the coverage enhancement level of the MTC terminal.

With reference to the second possible implementation manner of the third aspect, in a third possible implementation manner of the third aspect, the access module is configured to send the acquired preamble to a base station using the acquired predefined TF-resource, in order to notify the base station that the random access resources corresponding to the coverage enhancement level of the MTC terminal are insufficient.

With reference to the first possible implementation manner of the third aspect, in a fourth possible implementation manner of the third aspect, the random access resources include a TF-resource and a preamble resource, and correspondingly, the acquiring module is configured to acquire a predefined TF-resource in the TF-resources in the random access resources corresponding to the coverage enhancement level of the MTC terminal, and acquire a predefined preamble that is included in a preamble resource group in the random access resources corresponding to the coverage enhancement level of the MTC terminal.

With reference to the fourth possible implementation manner of the third aspect, in a fifth possible implementation manner of the third aspect, the access module is configured to send the acquired predefined preamble to a base station over the acquired predefined TF-resource, in order to notify the base station that the random access resources corresponding to the coverage enhancement level of the MTC terminal are insufficient.

With reference to the first possible implementation manner of the third aspect, in a sixth possible implementation manner of the third aspect, the random access resources include a TF-resource and a preamble resource, and correspondingly, the acquiring module is configured to acquire a preamble in predefined preamble resources and a TF-resource that is included in a TF-resource group in the random access resources corresponding to the coverage enhancement level of the MTC terminal.

With reference to the sixth possible implementation manner of the third aspect, in a seventh possible implementation manner of the third aspect, the access module is configured to send the acquired preamble in the predefined preamble resources to a base station over the acquired TF-resource, in order to notify the base station that the random access resources corresponding to the coverage enhancement level of the MTC terminal are insufficient.

With reference to the first possible implementation manner of the third aspect, in an eighth possible implementation manner of the third aspect, the random access resources include a TF-resource and a preamble resource, and correspondingly, the acquiring module is configured to acquire a predefined preamble in the preamble resources in the random access resources corresponding to the coverage enhancement level of the MTC terminal, and acquire a predefined TF-resource that is included in a TF-resource group in the random access resources corresponding to the coverage enhancement level of the MTC terminal.

With reference to the eighth possible implementation manner of the third aspect, in a ninth possible implementation manner of the third aspect, the access module is configured to send the acquired predefined preamble in the preamble resources corresponding to the MTC terminal to a base station over the acquired predefined TF-resource, in order to notify the base station that the random access resources corresponding to the coverage enhancement level of the MTC terminal are insufficient.

With reference to the first possible implementation manner of the third aspect, in a tenth possible implementation manner of the third aspect, the random access resources include a TF-resource and a preamble resource, and correspondingly, the acquiring module is configured to acquire a predefined TF-resource that is included in a TF-resource group in the random access resources corresponding to the coverage enhancement level of the MTC terminal, and a predefined preamble that is included in a preamble resource group in the random access resources corresponding to the coverage enhancement level of the MTC terminal.

With reference to the tenth possible implementation manner of the third aspect, in an eleventh possible implementation manner of the third aspect, the access module is configured to send the acquired predefined preamble to a base station over the acquired predefined TF-resource, in order to notify the base station that the random access resources corresponding to the coverage enhancement level of the MTC terminal are insufficient.

With reference to the first possible implementation manner of the third aspect, in a twelfth possible implementation manner of the third aspect, the random access resources include a TF-resource and a preamble resource, and correspondingly, the acquiring module is configured to acquire a preamble except the random access resources corresponding to the coverage enhancement level of the MTC terminal, and a predefined TF-resource that is included in a TF-resource group in the random access resources corresponding to the coverage enhancement level of the MTC terminal.

With reference to the twelfth possible implementation manner of the third aspect, in a thirteenth possible implementation manner of the third aspect, the access module is configured to send the acquired preamble to a base station over the acquired predefined TF-resource, in order to notify the base station that the random access resources corresponding to the coverage enhancement level of the MTC terminal are insufficient.

With reference to the first possible implementation manner of the third aspect, in a fourteenth possible implementation manner of the third aspect, the random access resources include a TF-resource and a preamble resource, and correspondingly, the acquiring module is configured to: acquire a TF-resource except the random access resources corresponding to the coverage enhancement level of the MTC terminal, and a predefined preamble that is included in a preamble resource group in the random access resources corresponding to the coverage enhancement level of the MTC terminal.

With reference to the fourteenth possible implementation manner of the third aspect, in a fifteenth possible implementation manner of the third aspect, the access module is configured to send the acquired predefined preamble to a base station over the acquired TF-resource, in order to notify the base station that the random access resources corresponding to the coverage enhancement level of the MTC terminal are insufficient.

With reference to the first possible implementation manner of the third aspect, in a sixteenth possible implementation manner of the third aspect, the random access resources include a TF-resource and a preamble resource, and correspondingly, the acquiring module is configured to acquire a predefined TF-resource except the random access resources corresponding to the coverage enhancement level of the MTC terminal, and a predefined preamble except the random access resources corresponding to the coverage enhancement level of the MTC terminal.

With reference to the sixteenth possible implementation manner of the third aspect, in a seventeenth possible implementation manner of the third aspect, the access module is configured to send the acquired predefined preamble to a base station over the acquired predefined TF-resource, in order to notify the base station that the random access resources corresponding to the coverage enhancement level of the MTC terminal are insufficient.

With reference to the first possible implementation manner of the third aspect, in an eighteenth possible implementation manner of the third aspect, the acquiring module is configured to acquire a coverage enhancement level except the coverage enhancement level of the MTC terminal, and acquire the predefined random access resources according to the acquired coverage enhancement level except the coverage enhancement level of the MTC terminal.

With reference to the eighteenth possible implementation manner of the third aspect, in a nineteenth possible implementation manner of the third aspect, the random access resources include a TF-resource and a preamble resource, and correspondingly, the acquiring module is configured to acquire a TF-resource and a preamble that are in random access resources corresponding to the coverage enhancement level except the coverage enhancement level of the MTC terminal.

With reference to the nineteenth possible implementation manner of the third aspect, in a twentieth possible implementation manner of the third aspect, the access module is configured to send the preamble in the random access resources corresponding to the coverage enhancement level except the coverage enhancement level of the MTC terminal, to a base station over the TF-resource in the random access resources corresponding to the coverage enhancement level except the coverage enhancement level of the MTC terminal, in order to initiate the random access process.

With reference to the eighteenth possible implementation manner of the third aspect, in a twenty-first possible implementation manner of the third aspect, the random access resources include a TF-resource and a preamble resource, and correspondingly, the acquiring module is configured to acquire a TF-resource in random access resources corresponding to the coverage enhancement level except the coverage enhancement level of the MTC terminal, and acquire a preamble in the preamble resources in the random access resources corresponding to the coverage enhancement level of the MTC terminal.

With reference to the twenty-first possible implementation manner of the third aspect, in a twenty-second possible implementation manner of the third aspect, the access module is configured to send the preamble in the preamble resources in the random access resources corresponding to the coverage enhancement level of the MTC terminal, to a base station over the TF-resource in the random access resources corresponding to the coverage enhancement level except the coverage enhancement level of the MTC terminal, in order to initiate the random access process.

With reference to the eighteenth possible implementation manner of the third aspect, in a twenty-third possible implementation manner of the third aspect, the random access resources include a TF-resource and a preamble resource, and correspondingly, the acquiring module is configured to acquire a preamble resource in random access resources corresponding to the coverage enhancement level except the coverage enhancement level of the MTC terminal, and acquire a TF-resource in the TF-resources in the random access resources corresponding to the coverage enhancement level of the MTC terminal.

With reference to the twenty-third possible implementation manner of the third aspect, in a twenty-fourth possible implementation manner of the third aspect, the access module is configured to send the preamble resource in the random access resources corresponding to the coverage enhancement level except the coverage enhancement level of the MTC terminal, to a base station over the TF-resource in the TF-resources in the random access resources corresponding to the coverage enhancement level of the MTC terminal, so as to initiate the random access process.

With reference to the eighteenth possible implementation manner of the third aspect, in a twenty-fifth possible implementation manner of the third aspect, the random access resources include a TF-resource and a preamble resource; and correspondingly, the acquiring module is configured to acquire a TF-resource in random access resources corresponding to the coverage enhancement level except the coverage enhancement level of the MTC terminal, and acquire a preamble that is included in a preamble resource group in the random access resources corresponding to the coverage enhancement level of the MTC terminal.

With reference to the twenty-fifth possible implementation manner of the third aspect, in a twenty-sixth possible implementation manner of the third aspect, the access module is configured to send the preamble to a base station over the acquired TF-resource, in order to initiate the random access process.

With reference to the twentieth, the twenty-second, the twenty-fourth, or the twenty-sixth possible implementation manner of the third aspect, in a twenty-seventh possible implementation manner of the third aspect, the terminal further includes a notification module configured to notify the base station that the random access resources corresponding to the coverage enhancement level of the MTC terminal are insufficient.

With reference to the eighteenth possible implementation manner of the third aspect, in a twenty-eighth possible implementation manner of the third aspect, the random access resources include a TF-resource and a preamble resource, and correspondingly, the access module is configured to acquire, according to the coverage enhancement level of the MTC terminal and/or the coverage enhancement level except the coverage enhancement level of the MTC terminal, power at which the MTC terminal sends a preamble, and send the acquired preamble to a base station over the acquired TF-resource at the acquired power for sending the preamble, so as to initiate the random access process.

With reference to the first possible implementation manner of the third aspect, in a twenty-ninth possible implementation manner of the third aspect, the terminal further includes a first receiving module configured to receive a response RAR message sent by a base station, and a sending module configured to send a random access process message 3 to the base station according to the RAR message, where the random access process message 3 carries coverage enhancement level information of the MTC terminal.

With reference to the twenty-ninth possible implementation manner of the third aspect, in a thirtieth possible implementation manner of the third aspect, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

With reference to the third aspect, in a thirty-first possible implementation manner of the third aspect, the terminal further includes, a second receiving module configured to receive configuration information sent by a base station, where the configuration information carries identifiers of the predefined random access resources.

According to a fourth aspect, the present disclosure provides a base station, where the base station includes a sending module configured to send configuration information to an MTC terminal, where the configuration information carries identifiers of predefined random access resources, such that the MTC terminal acquires the predefined random access resources according to the configuration information, and an accepting module configured to accept a random access process that is initiated by the MTC terminal using the acquired predefined random access resources.

With reference to the fourth aspect, in a first possible implementation manner of the fourth aspect, the accepting module is further configured to determine, according to the random access process that is initiated by the MTC terminal over the predefined random access resources, that random access resources corresponding to the MTC terminal are insufficient.

With reference to the first possible implementation manner of the fourth aspect, in a second possible implementation manner of the fourth aspect, the MTC terminal is a terminal that requires coverage enhancement, and correspondingly, the accepting module is configured to determine, according to the predefined random access resources, that random access resources corresponding to a coverage enhancement level of the MTC terminal are insufficient.

With reference to the fourth aspect, in a third possible implementation manner of the fourth aspect, the MTC terminal is a terminal that requires coverage enhancement, and correspondingly, the accepting module is configured to send a response RAR message to the MTC terminal, such that the MTC terminal sends a message 3 to the base station according to the RAR message, and receive the message 3 sent by the MTC terminal, where the message 3 carries coverage enhancement level information of the MTC terminal.

With reference to the third possible implementation manner of the fourth aspect, in a fourth possible implementation manner of the fourth aspect, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

With reference to the second or the fourth possible implementation manner of the fourth aspect, in a fifth possible implementation manner of the fourth aspect, the base station further includes a second determining module configured to determine the coverage enhancement level of the MTC terminal.

With reference to the fifth possible implementation manner of the fourth aspect, in a sixth possible implementation manner of the fourth aspect, the second determining module is configured to determine the coverage enhancement level of the MTC terminal according to the predefined random access resources and/or the message 3.

With reference to the fifth possible implementation manner of the fourth aspect, in a seventh possible implementation manner of the fourth aspect, the base station further includes an increasing module configured to increase the random access resources corresponding to the coverage enhancement level of the MTC terminal.

With reference to the seventh possible implementation manner of the fourth aspect, in an eighth possible implementation manner of the fourth aspect, the random access resources include a TF-resource and a preamble resource, and correspondingly, the increasing module is configured to acquire a first predefined quantity of TF-resources from a TF-resource group in random access resources corresponding to a coverage enhancement level except the coverage enhancement level of the MTC terminal, or acquire a second predefined quantity of TF-resources from TF-resources in random access resources corresponding to a coverage enhancement level except the coverage enhancement level of the MTC terminal, or acquire a third predefined quantity of TF-resources from TF-resources except random access resources corresponding to all coverage enhancement levels in the base station, and transfer the acquired first predefined quantity of TF-resources, or the acquired second predefined quantity of TF-resources, or the acquired third predefined quantity of TF-resources to the random access resources corresponding to the coverage enhancement level of the MTC terminal, where the first predefined quantity is less than or equal to a quantity of TF-resources that are included in the TF-resource group, the second predefined quantity is less than or equal to a quantity of TF-resources that are included in the TF-resources, and the third predefined quantity is less than or equal to a quantity of TF-resources that are included in the TF-resources except the random access resources corresponding to all the coverage enhancement levels in the base station.

With reference to the seventh possible implementation manner of the fourth aspect, in a ninth possible implementation manner of the fourth aspect, the random access resources include a TF-resource and a preamble resource, and correspondingly, the increasing module is configured to acquire a fourth predefined quantity of preambles from a preamble resource group in random access resources corresponding to a coverage enhancement level except the coverage enhancement level of the MTC terminal, or acquire a fifth predefined quantity of preambles from preamble resources in random access resources corresponding to a coverage enhancement level except the coverage enhancement level of the MTC terminal, or acquire a sixth predefined quantity of preambles from preamble resources except random access resources corresponding to all coverage enhancement levels in the base station, and transfer the acquired fourth predefined quantity of preambles, or the acquired fifth predefined quantity of preambles, or the acquired sixth predefined quantity of preambles to the random access resources corresponding to the coverage enhancement level of the MTC terminal, where the fourth predefined quantity is less than or equal to a quantity of preambles that are included in the preamble resource group, the fifth predefined quantity is less than or equal to a quantity of preambles that are included in the preamble resources, and the sixth predefined quantity is less than or equal to a quantity of preambles that are included in the preamble resources except the random access resources corresponding to all the coverage enhancement levels in the base station.

With reference to the seventh possible implementation manner of the fourth aspect, in a tenth possible implementation manner of the fourth aspect, the random access resources include a TF-resource and a preamble resource, and correspondingly, the increasing module is configured to acquire a seventh predefined quantity of TF-resources and an eighth predefined quantity of preambles respectively from a TF-resource group and a preamble resource group that are in random access resources corresponding to a coverage enhancement level except the coverage enhancement level of the MTC terminal, and transfer the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group, or the increasing module is configured to acquire a ninth predefined quantity of TF-resources and a tenth predefined quantity of preambles respectively from TF-resources and preamble resources that are in random access resources corresponding to a coverage enhancement level except the coverage enhancement level of the MTC terminal, and transfer the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources, or the increasing module is configured to: acquire an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transfer the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

With reference to the fifth possible implementation manner of the fourth aspect, in an eleventh possible implementation manner of the fourth aspect, the accepting module is configured to receive a preamble that is included in a preamble resource group in the random access resources corresponding to the coverage enhancement level of the MTC terminal and that is sent by the MTC terminal over a TF-resource in predefined TF-resources, and determine that the random access resources corresponding to the coverage enhancement level of the MTC terminal are insufficient.

With reference to the fifth possible implementation manner of the fourth aspect, in a twelfth possible implementation manner of the fourth aspect, the accepting module is configured to receive a predefined preamble that is included in a preamble resource group in the random access resources corresponding to the coverage enhancement level of the MTC terminal, and that is sent by the MTC terminal over a predefined TF-resource in TF-resources in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a thirteenth possible implementation manner of the fourth aspect, the accepting module is configured to receive a preamble that is in predefined preamble resources and is sent by the MTC terminal over a TF-resource that is included in a TF-resource group in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a fourteenth possible implementation manner of the fourth aspect, the accepting module is configured to receive a predefined preamble that is in preamble resources in the random access resources corresponding to the coverage enhancement level of the MTC terminal, and that is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a fifteenth possible implementation manner of the fourth aspect, the accepting module is configured to receive a predefined preamble that is included in a preamble resource group and is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a sixteenth possible implementation manner of the fourth aspect, the accepting module is configured to receive a preamble, except the random access resources corresponding to the coverage enhancement level of the MTC terminal, that is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a seventeenth possible implementation manner of the fourth aspect, the accepting module is configured to receive a predefined preamble that is included in a preamble resource group in the random access resources corresponding to the coverage enhancement level of the MTC terminal, and that is sent by the MTC terminal over a TF-resource except the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in an eighteenth possible implementation manner of the fourth aspect, the accepting module is configured to receive a predefined preamble, except the random access resources corresponding to the coverage enhancement level of the MTC terminal, that is sent by the MTC terminal over a predefined TF-resource except the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a nineteenth possible implementation manner of the fourth aspect, the accepting module is configured to receive a preamble that is in random access resources corresponding to a coverage enhancement level except the coverage enhancement level of the MTC terminal, and that is sent by the MTC terminal over a TF-resource in the random access resources corresponding to the coverage enhancement level except the coverage enhancement level of the MTC terminal, and determine that the random access resources corresponding to the coverage enhancement level of the MTC terminal are insufficient.

With reference to the fifth possible implementation manner of the fourth aspect, in a twentieth possible implementation manner of the fourth aspect, the accepting module is configured to receive a preamble resource that is in random access resources corresponding to a coverage enhancement level except the coverage enhancement level of the MTC terminal, and that is sent by the MTC terminal over a TF-resource in TF-resources in the random access resources corresponding to the coverage enhancement level of the MTC terminal, and determine that the random access resources corresponding to the coverage enhancement level of the MTC terminal are insufficient.

With reference to the fifth possible implementation manner of the fourth aspect, in a twenty-first possible implementation manner of the fourth aspect, the accepting module is configured to receive a preamble that is included in a preamble resource group in the random access resources corresponding to the coverage enhancement level of the MTC terminal, and that is sent by the MTC terminal over a TF-resource in random access resources corresponding to a coverage enhancement level except the coverage enhancement level of the MTC terminal, and determine that the random access resources corresponding to the coverage enhancement level of the MTC terminal are insufficient.

According to a fifth aspect, the present disclosure provides a terminal, where the terminal includes a first memory and a first processor, which are configured to execute the method for randomly accessing a network according to the first aspect.

According to a sixth aspect, the present disclosure provides a base station, where the base station includes a second memory and a second processor, which are configured to execute the method for randomly accessing a network according to the second aspect.

In the embodiments of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of a method for randomly accessing a network according to Embodiment 1 of the present disclosure;

FIG. 2 is a flowchart of a method for randomly accessing a network according to Embodiment 1 of the present disclosure;

FIG. 3 is a flowchart of a method for randomly accessing a network according to Embodiment 2 of the present disclosure;

FIG. 4 is a flowchart of a method for randomly accessing a network according to Embodiment 3 of the present disclosure;

FIG. 5 is a flowchart of a method for randomly accessing a network according to Embodiment 4 of the present disclosure;

FIG. 6 is a flowchart of a method for randomly accessing a network according to Embodiment 5 of the present disclosure;

FIG. 7 is a schematic diagram of a structure of a terminal according to Embodiment 6 of the present disclosure;

FIG. 8 is another schematic diagram of a structure of a terminal according to Embodiment 6 of the present disclosure;

FIG. 9 is a schematic diagram of a structure of a base station according to Embodiment 7 of the present disclosure;

FIG. 10 is another schematic diagram of a structure of a base station according to Embodiment 7 of the present disclosure;

FIG. 11 is a schematic diagram of a structure of a terminal according to Embodiment 8 of the present disclosure; and

FIG. 12 is a schematic diagram of a structure of a base station according to Embodiment 9 of the present disclosure.

### DESCRIPTION OF EMBODIMENTS

To make the objectives, technical solutions, and advantages of the present disclosure clearer, the following further describes the embodiments of the present disclosure in detail with reference to the accompanying drawings.

### Embodiment 1

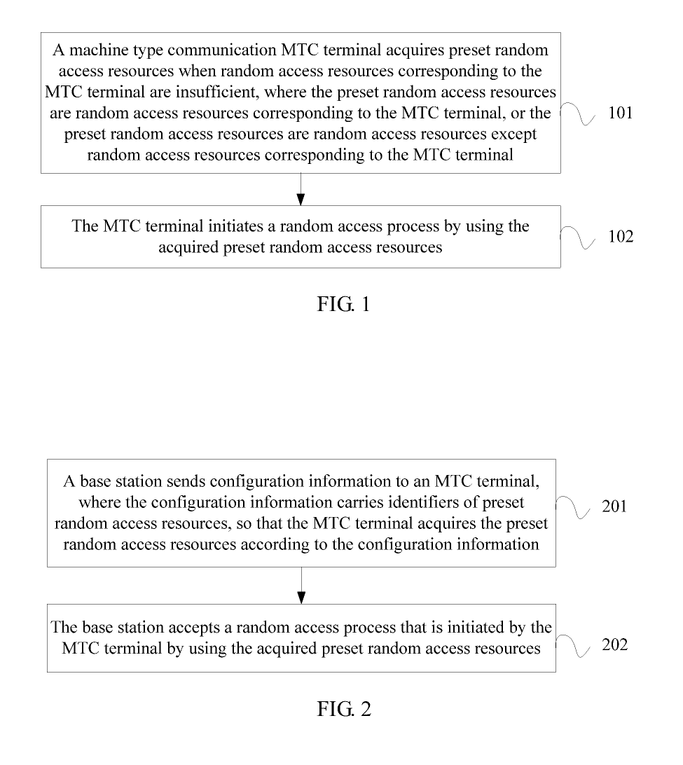

The present embodiment of the disclosure provides a method for randomly accessing a network. Referring to FIG. 1, the method includes the following steps:

Step 101: A MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal.

Step 102: The MTC terminal initiates a random access process using the acquired predefined random access resources.

Further, the present embodiment of the disclosure provides a method for randomly accessing a network. Referring to FIG. 2, the method includes the following steps:

Step 201: A base station sends configuration information to an MTC terminal, where the configuration information carries identifiers of predefined random access resources, such that the MTC terminal acquires the predefined random access resources according to the configuration information.

Step 202: The base station accepts a random access process that is initiated by the MTC terminal using the acquired predefined random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved.

### Embodiment 2

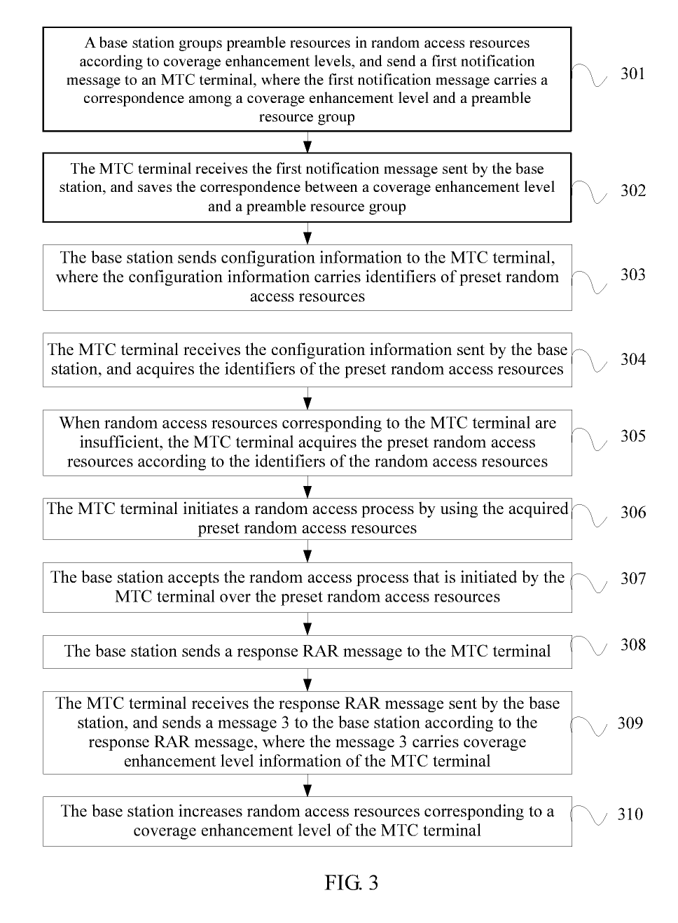

This embodiment of the present disclosure provides a method for randomly accessing a network. Grouping preamble resources in random access resources is used as an example for description in this embodiment of the present disclosure. Referring to FIG. 3, the method includes the following steps:

Step 301: A base station groups preamble resources in random access resources according to coverage enhancement levels, and sends a first notification message to an MTC terminal, where the first notification message carries a correspondence between a coverage enhancement level and a preamble resource group.

The random access resources include a TF-resource and a preamble resource. The coverage enhancement level refers to a level of degree to which coverage needs to be enhanced when the MTC terminal communicates with the base station, and different coverage enhancement levels are corresponding to different coverage enhancement technologies or different combinations of coverage enhancement technologies. The MTC terminal is any MTC terminal for which the base station provides a service.

The base station allocates preambles that are included in the preamble resources in the random access resources to each coverage enhancement level according to the coverage enhancement levels, for example, allocates, in an even manner, the preamble resources evenly to each coverage enhancement level, and sends the first notification message to all MTC terminals for which the base station provides a service, where the first notification message carries the correspondence between a coverage enhancement level and a preamble resource group.

The MTC terminal may acquire, according to a coverage enhancement level of the MTC terminal, a preamble resource group in random access resources corresponding to the coverage enhancement level of the MTC terminal, and acquire a preamble from the preamble resource group.

For example, preamble resources in random access resources of a base station include 64 preambles, which are a preamble 0, a preamble 1, . . . , and a preamble 63, respectively. There are eight coverage enhancement levels in the base station in total, which are a coverage enhancement level 0, a coverage enhancement level 1, . . . , and a coverage enhancement level 7, respectively. Therefore, the base station allocates the 64 preambles evenly to the eight coverage enhancement levels according to the coverage enhancement levels, and random access resources of each coverage enhancement level are corresponding to eight preambles. That is, a preamble group 0 corresponding to the coverage enhancement level 0 includes the preamble 0, the preamble 1, . . . , and a preamble 7; a preamble group 1 corresponding to the coverage enhancement level 1 includes a preamble 8, a preamble 9, . . . , and a preamble 15; . . . ; a preamble group 7 corresponding to the coverage enhancement level 7 includes a preamble 56, a preamble 57, . . . , and the preamble 63.

Step 302: The MTC terminal receives the first notification message sent by the base station, and saves the correspondence between a coverage enhancement level and a preamble resource group.

The MTC terminal saves the correspondence between a coverage enhancement level and a preamble resource group. When randomly accessing a network, the MTC terminal determines a preamble resource group according to a coverage enhancement level, selects one preamble from the preamble resource group, and randomly accesses the network using the selected preamble.

Step 303: The base station sends configuration information to the MTC terminal, where the configuration information carries identifiers of predefined random access resources.

The configuration information may further carry a correspondence between an identifier of a predefined random access resource and a predefined period. When random access resources corresponding to the MTC terminal are insufficient, the MTC terminal may acquire a predefined period according to the configuration information, and acquire a predefined random access resource according to the predefined period.

The predefined random access resources are used such that the MTC terminal initiates, using the predefined random access resources, a random access process when the random access resources corresponding to the coverage enhancement level of the MTC terminal are insufficient.

The predefined random access resources are further used to notify the base station that the random access resources corresponding to the coverage enhancement level of the MTC terminal are insufficient.

In this embodiment of the present disclosure, the predefined random access resources are TF-resources in predefined TF-resources, or the predefined random access resources are a predefined preamble that is included in preamble resources in the random access resources corresponding to the coverage enhancement level of the MTC terminal, and a predefined TF-resource that is included in TF-resources in the random access resources corresponding to the coverage enhancement level of the MTC terminal.

The predefined random access resources appear periodically, or the predefined random access resources are configured by a system. For example, it is configured on the base station that a predefined TF-resource appears once every 5 seconds (s).

Step 304: The MTC terminal receives the configuration information sent by the base station, and acquires the identifiers of the predefined random access resources.

Step 305: When random access resources corresponding to the MTC terminal are insufficient, the MTC terminal acquires the predefined random access resources according to the identifiers of the predefined random access resources.

Before the MTC terminal acquires the predefined random access resources when the random access resources corresponding to the MTC terminal are insufficient, the MTC terminal determines the coverage enhancement level of the MTC terminal, acquires, according to the coverage enhancement level of the MTC terminal, the random access resources corresponding to the coverage enhancement level of the MTC terminal, and uses the random access resources corresponding to the coverage enhancement level of the MTC terminal, as the random access resources corresponding to the MTC terminal.

The operation of determining, by the MTC terminal, the coverage enhancement level of the MTC terminal may be determining, by the MTC terminal according to its own path loss, the coverage enhancement level of the MTC terminal.

Correspondingly, that the random access resources corresponding to the MTC terminal are insufficient may be that the random access resources corresponding to the coverage enhancement level of the MTC terminal are insufficient.

A method for detecting, by the MTC terminal, that the random access resources corresponding to the coverage enhancement level of the MTC terminal are insufficient: there may be a relatively high probability that a conflict occurs in initiating a random access process by the MTC terminal.

The operation of detecting, by the MTC terminal, that there is a relatively high probability that a conflict occurs in initiating a random access process by the MTC terminal may be when the MTC terminal still fails to access a network after initiating the random access process for a predefined quantity of times, determining, by the MTC terminal, that there is a relatively high probability that a conflict occurs in initiating the random access process, that is, the random access resources corresponding to the coverage enhancement level of the MTC terminal are insufficient.

The predefined quantity of times may be set and changed by the base station according to the coverage enhancement level of the MTC terminal. The predefined quantity of times is not further limited in the present disclosure.

The operation of acquiring, by the MTC terminal, the predefined random access resources according to the identifiers of the predefined random access resources may be acquiring, by the MTC terminal according to the identifiers of the predefined random access resources, the TF-resource in the predefined TF-resources and the preamble that is included in the preamble resource group in the random access resources corresponding to the coverage enhancement level of the MTC terminal.

Alternatively, the operation of acquiring, by the MTC terminal, the predefined random access resources according to the identifiers of the predefined random access resources may be acquiring, by the MTC terminal according to the identifiers of the predefined random access resources, the predefined TF-resource in the TF-resources in the random access resources corresponding to the coverage enhancement level of the MTC terminal, and acquiring a predefined preamble in the preamble resource group in the random access resources corresponding to the coverage enhancement level of the MTC terminal.

The predefined TF-resource may appear periodically, and the predefined preamble may appear periodically.

For example, the predefined TF-resource appears once in the system every predefined period, or the predefined preamble in the preamble resource group in the random access resources corresponding to the coverage enhancement level of the MTC terminal appears once every predefined period.

In this embodiment of the present disclosure, the MTC terminal may also receive, when the random access resources corresponding to the MTC terminal are insufficient, the configuration information sent by the base station, and acquire the identifiers of the predefined random access resources, which is not further limited in the present disclosure.

Step 306: The MTC terminal initiates a random access process using the acquired predefined random access resources.

The MTC terminal may initiate, using the predefined random access resources, the random access process and may further notify the base station that the random access resources corresponding to the coverage enhancement level of the MTC terminal are insufficient.

When the MTC terminal acquires the predefined TF-resource and the preamble that is included in the preamble resource group in the random access resources corresponding to the coverage enhancement level of the MTC terminal, the operation of initiating, by the MTC terminal, the random access process using the acquired predefined random access resources may be sending, by the MTC terminal, the preamble that is included in the preamble resource group in the random access resources corresponding to the coverage enhancement level of the MTC terminal, to the base station over the TF-resource in the predefined TF-resources, in order to initiate the random access process.

Further, the MTC terminal sends, to the base station over the TF-resource in the predefined TF-resources, the preamble that is included in the preamble resource group in the random access resources corresponding to the coverage enhancement level of the MTC terminal, in order to notify the base station that the random access resources corresponding to the coverage enhancement level of the MTC terminal are insufficient.

When the operation of acquiring, by the MTC terminal, the predefined random access resources is acquiring, by the MTC terminal, the predefined TF-resource in the TF-resources in the random access resources corresponding to the MTC terminal, and acquiring the predefined preamble in the preamble resource group in the random access resources corresponding to the coverage enhancement level of the MTC terminal, the operation of initiating, by the MTC terminal, the random access process using the acquired predefined random access resources may be sending, by the MTC terminal, the predefined preamble in the preamble resource group in the random access resources corresponding to the coverage enhancement level of the MTC terminal, to the base station over the predefined TF-resource in the TF-resources in the random access resources corresponding to the MTC terminal, in order to initiate the random access process.

Further, the MTC terminal sends the predefined preamble in the preamble resource group in the random access resources corresponding to the coverage enhancement level of the MTC terminal, to the base station over the predefined TF-resource in the TF-resources in the random access resources corresponding to the MTC terminal, in order to notify the base station that the random access resources corresponding to the coverage enhancement level of the MTC terminal are insufficient.

Step 307: The base station accepts the random access process that is initiated by the MTC terminal over the predefined random access resources.

The base station determines, according to the random access process that is initiated by the MTC terminal over the predefined random access resources, that the random access resources corresponding to the MTC terminal are insufficient.

In this embodiment of the present disclosure, the operation of accepting, by the base station, the random access process that is initiated by the MTC terminal over the predefined random access resources may be receiving, by the base station, the preamble that is included in the preamble resource group in the random access resources corresponding to the coverage enhancement level of the MTC terminal and that is sent by the MTC terminal over the TF-resource in the predefined TF-resources, or receiving, by the base station, the predefined preamble that is in the preamble resource group in the random access resources corresponding to the coverage enhancement level of the MTC terminal, and that is sent by the MTC terminal over the predefined TF-resource in the random access resources corresponding to the coverage enhancement level of the MTC terminal.

The operation of determining, by the base station according to the random access process that is initiated by the MTC terminal over the predefined random access resources, that the random access resources corresponding to the MTC terminal are insufficient may be determining, by the base station according to the predefined random access resources, that the random access resources corresponding to the coverage enhancement level of the MTC terminal are insufficient.

Further, the base station determines the coverage enhancement level of the MTC terminal according to the predefined random access resources.

In this embodiment of the present disclosure, when the MTC terminal initiates, using the predefined random access resources, the random access process to notify the base station that the random access resources corresponding to the coverage enhancement level of the MTC terminal are insufficient, the base station may further determine, according to the random access process that is initiated by the MTC terminal over the predefined random access resources, that the random access resources corresponding to the coverage enhancement level of the MTC terminal are insufficient, and determine the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may be receiving, by the base station, the preamble that is included in the preamble resource group in the random access resources corresponding to the coverage enhancement level of the MTC terminal and that is sent by the MTC terminal over the TF-resource in the predefined TF-resources and determining that the random access resources corresponding to the coverage enhancement level of the MTC terminal are insufficient.

Further, the base station determines the coverage enhancement level of the MTC terminal according to the preamble that is included in the preamble resource group in the random access resources corresponding to the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may further be receiving, by the base station, the predefined preamble that is in the preamble resource group in the random access resources corresponding to the coverage enhancement level of the MTC terminal, and that is sent by the MTC terminal over the predefined TF-resource in the TF-resources in the random access resources corresponding to the coverage enhancement level of the MTC terminal, and determining that the random access resources corresponding to the coverage enhancement level of the MTC terminal are insufficient.

Further, the base station determines the coverage enhancement level of the MTC terminal according to the predefined TF-resource in the TF-resources in the random access resources corresponding to the coverage enhancement level of the MTC terminal and/or the predefined preamble in the preamble resource group in the random access resources corresponding to the coverage enhancement level of the MTC terminal.

For example, the base station receives a preamble 10 that is sent by the MTC terminal over a predefined TF-resource, determines, according to the predefined TF-resource, that random access resources corresponding to a coverage enhancement level are insufficient, and determines, according to the preamble 10, that the coverage enhancement level of the MTC terminal is the coverage enhancement level 1.

Step 308: The base station sends a response RAR message to the MTC terminal.

The response RAR message is used to notify the MTC terminal that the base station has received the random access process initiated by the MTC terminal.

Step 309: The MTC terminal receives the response RAR message sent by the base station, and sends a message 3 to the base station according to the response RAR message, where the message 3 carries coverage enhancement level information of the MTC terminal.

The coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the base station receives the message 3 sent by the MTC terminal, and determines the coverage enhancement level of the MTC terminal according to the coverage enhancement level information that is of the MTC terminal and carried in the message 3.

Step 310: The base station increases random access resources corresponding to a coverage enhancement level of the MTC terminal.

The operation of increasing, by the base station, the random access resources corresponding to the coverage enhancement level of the MTC terminal may be acquiring, by the base station, a fourth predefined quantity of preambles from a preamble resource group in random access resources corresponding to a coverage enhancement level except the coverage enhancement level of the MTC terminal, and transferring the acquired fourth predefined quantity of preambles to the random access resources corresponding to the coverage enhancement level of the MTC terminal, where the fourth predefined quantity is less than or equal to a quantity of preambles that are included in the preamble resource group.

The operation of increasing, by the base station, the random access resources corresponding to the coverage enhancement level of the MTC terminal may further be acquiring, by the base station, a fifth predefined quantity of preambles from preamble resources in random access resources corresponding to a coverage enhancement level except the coverage enhancement level of the MTC terminal, and transferring the acquired fifth predefined quantity of preambles to the random access resources corresponding to the coverage enhancement level of the MTC terminal, where the fifth predefined quantity is less than or equal to a quantity of preambles that are included in the preamble resources.

The operation of increasing, by the base station, the random access resources corresponding to the coverage enhancement level of the MTC terminal may further be acquiring, by the base station, a sixth predefined quantity of preambles from preamble resources except random access resources corresponding to all coverage enhancement levels in the base station, and transferring the acquired sixth predefined quantity of preambles to the random access resources corresponding to the coverage enhancement level of the MTC terminal, where the sixth predefined quantity is less than or equal to a quantity of preambles that are included in the preamble resources except the random access resources corresponding to all the coverage enhancement levels in the base station.

The base station may randomly select a coverage enhancement level except the coverage enhancement level of the MTC terminal, and the base station may also determine, according to a historical record, a coverage enhancement level corresponding to sufficient random access resources.

For example, the base station determines, according to a historical record, that random access resources corresponding to a coverage enhancement level 4 are sufficient. The base station acquires a preamble 20 that is included in a preamble resource group in the random access resources corresponding to the coverage enhancement level 4, and transfers the preamble 20 to random access resources corresponding to the coverage enhancement level 1 of the MTC terminal.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process by using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 3

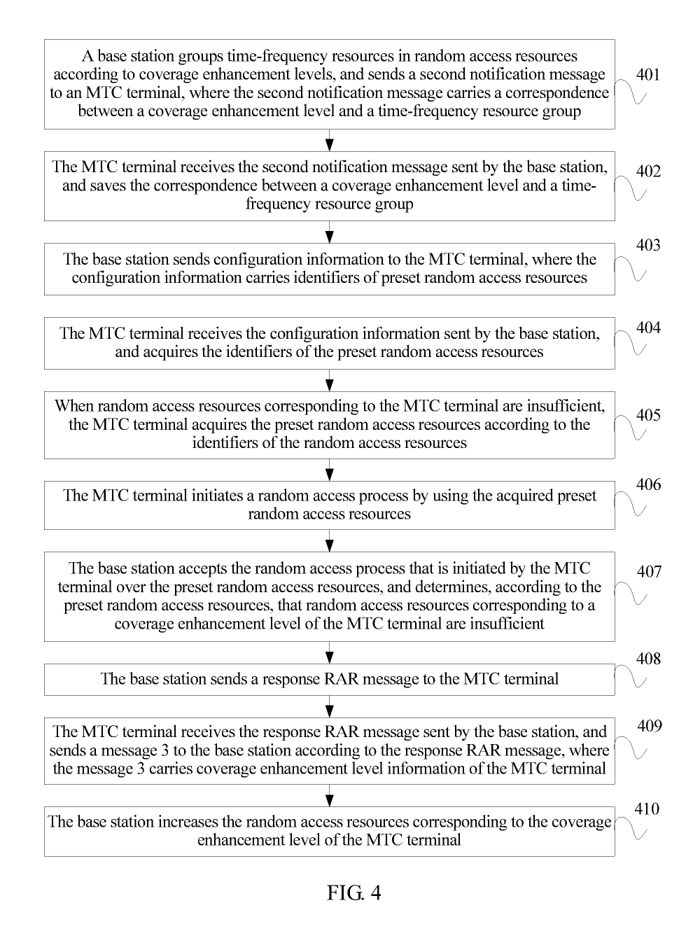

This embodiment of the present disclosure provides a method for randomly accessing a network. Grouping TF-resources in random access resources is used as an example for description in this embodiment of the present disclosure. Referring to FIG. 4, the method includes the following steps:

Step 401: A base station groups TF-resources in random access resources according to coverage enhancement levels, and sends a second notification message to an MTC terminal, where the second notification message carries a correspondence between a coverage enhancement level and a TF-resource group.

The random access resources include a TF-resource and a preamble resource. The coverage enhancement level refers to a level of degree to which coverage needs to be enhanced when the MTC terminal communicates with the base station, and different coverage enhancement levels are corresponding to different coverage enhancement technologies or different combinations of coverage enhancement technologies. The MTC terminal is any MTC terminal for which the base station provides a service.

The base station allocates TF-resources that are included in the TF-resources in the random access resources to each coverage enhancement level according to the coverage enhancement levels, for example, allocates, in an even manner, the TF-resources evenly to each coverage enhancement level, and sends the second notification message to all MTC terminals for which the base station provides a service, where the second notification message includes the correspondence between a coverage enhancement level and a TF-resource group.

The MTC terminal may acquire, according to a coverage enhancement level of the MTC terminal, a TF-resource in a TF-resource group in random access resources corresponding to the coverage enhancement level of the MTC terminal.

Step 402: The MTC terminal receives the second notification message sent by the base station, and saves the correspondence between a coverage enhancement level and a TF-resource group.

The MTC terminal saves the correspondence between a coverage enhancement level and a TF-resource group. When randomly accessing a network, the MTC terminal determines a TF-resource group according to a coverage enhancement level, selects one TF-resource from the TF-resource group, and randomly accesses the network using the selected TF-resource.

Step 403: The base station sends configuration information to the MTC terminal, where the configuration information carries identifiers of predefined random access resources.

The configuration information may further carry a correspondence between an identifier of a predefined random access resource and a predefined period. When random access resources corresponding to the MTC terminal are insufficient, the MTC terminal may acquire a predefined period according to the configuration information, and acquire a predefined random access resource according to the predefined period.

The predefined random access resources are used such that the MTC terminal initiates, using the predefined random access resources, a random access process when the random access resources corresponding to the coverage enhancement level of the MTC terminal are insufficient.

The predefined random access resources are further used to notify the base station that the random access resources corresponding to the coverage enhancement level of the MTC terminal are insufficient.

In this embodiment of the present disclosure, the predefined random access resources are preambles in predefined preamble resources, or the predefined random access resources are a predefined TF-resource that is included in a TF-resource group in the random access resources corresponding to the coverage enhancement level of the MTC terminal, and a predefined preamble that is included in preamble resources in the random access resources corresponding to the coverage enhancement level of the MTC terminal.

The predefined random access resources may appear periodically, or the predefined random access resources are configured by a system. For example, it is configured on the base station that a predefined TF-resource appears once every 5 s.

Step 404: The MTC terminal receives the configuration information sent by the base station, and acquires the identifiers of the predefined random access resources.

Step 405: When random access resources corresponding to the MTC terminal are insufficient, the MTC terminal acquires the predefined random access resources according to the identifiers of the predefined random access resources.

Before the MTC terminal acquires the predefined random access resources when the random access resources corresponding to the MTC terminal are insufficient, the MTC terminal determines the coverage enhancement level of the MTC terminal, acquires, according to the coverage enhancement level of the MTC terminal, the random access resources corresponding to the coverage enhancement level of the MTC terminal, and uses the random access resources corresponding to the coverage enhancement level of the MTC terminal, as the random access resources corresponding to the MTC terminal.

The operation of determining, by the MTC terminal, the coverage enhancement level of the MTC terminal may be determining, by the MTC terminal according to its own path loss, the coverage enhancement level of the MTC terminal.

Correspondingly, that the random access resources corresponding to the MTC terminal are insufficient may be that the random access resources corresponding to the coverage enhancement level of the MTC terminal are insufficient.

A method for detecting, by the MTC terminal, that the random access resources corresponding to the coverage enhancement level of the MTC terminal are insufficient may be: There is a relatively high probability that a conflict occurs in initiating a random access process by the MTC terminal.

The operation of detecting, by the MTC terminal, that there is a relatively high probability that a conflict occurs in initiating a random access process by the MTC terminal may be: when the MTC terminal still fails to access a network after initiating the random access process for a predefined quantity of times, determining, by the MTC terminal, that there is a relatively high probability that a conflict occurs in initiating the random access process, that is, the random access resources corresponding to the coverage enhancement level of the MTC terminal are insufficient.

The predefined quantity of times may be set and changed by the base station according to the coverage enhancement level of the MTC terminal. The predefined quantity of times is not further limited in the present disclosure.

The operation of acquiring, by the MTC terminal, the predefined random access resources according to the identifiers of the predefined random access resources may be acquiring, by the MTC terminal according to the identifiers of the predefined random access resources, the preamble in the predefined preamble resources and the TF-resource that is included in the TF-resource group in the random access resources corresponding to the coverage enhancement level of the MTC terminal.

Alternatively, the operation of acquiring, by the MTC terminal, the predefined random access resources according to the identifiers of the predefined random access resources may be acquiring, by the MTC terminal according to the identifiers of the predefined random access resources, the predefined preamble in the preamble resources in the random access resources corresponding to the coverage enhancement level of the MTC terminal, and acquiring, by the MTC terminal, the predefined TF-resource that is included in the TF-resource group in the random access resources corresponding to the coverage enhancement level of the MTC terminal.

The predefined preamble may appear periodically, and the predefined TF-resource may appear periodically.

For example, the predefined preamble appears once in the system every predefined period, or the predefined TF-resource that is included in the TF-resource group in the random access resources corresponding to the coverage enhancement level of the MTC terminal appears once every predefined period.

In this embodiment of the present disclosure, the MTC terminal may also receive, when the random access resources corresponding to the MTC terminal are insufficient, the configuration information sent by the base station, and acquire the identifiers of the predefined random access resources, which is not further limited in the present disclosure.

Step 406: The MTC terminal initiates a random access process using the acquired predefined random access resources.

When the operation of acquiring, by the MTC terminal, the predefined random access resources is acquiring, by the MTC terminal, the preamble in the predefined preamble resources and the TF-resource that is included in the TF-resource group in the random access resources corresponding to the coverage enhancement level of the MTC terminal, the operation of initiating, by the MTC terminal, the random access process using the acquired predefined random access resources may be sending, by the MTC terminal, the acquired preamble to the base station over the acquired TF-resource, in order to initiate the random access process.

Further, the MTC terminal sends the acquired preamble to the base station over the acquired TF-resource, in order to notify the base station that the random access resources corresponding to the coverage enhancement level of the MTC terminal are insufficient.

When the operation of acquiring, by the MTC terminal, the predefined random access resources is acquiring, by the MTC terminal, the predefined preamble in the preamble resources in the random access resources corresponding to the coverage enhancement level of the MTC terminal, and acquiring, by the MTC terminal, the predefined TF-resource that is included in the TF-resource group in the random access resources corresponding to the coverage enhancement level of the MTC terminal, the operation of initiating, by the MTC terminal, the random access process using the acquired predefined random access resources may be sending, by the MTC terminal, the acquired predefined preamble to the base station over the acquired predefined TF-resource, in order to initiate the random access process.

Further, the MTC terminal sends the acquired predefined preamble to the base station over the acquired predefined TF-resource, in order to notify the base station that the random access resources corresponding to the coverage enhancement level of the MTC terminal are insufficient.

Step 407: The base station accepts the random access process that is initiated by the MTC terminal over the predefined random access resources, and determines, according to the predefined random access resources, that random access resources corresponding to a coverage enhancement level of the MTC terminal are insufficient.

The base station determines, according to the random access process that is initiated by the MTC terminal over the predefined random access resources, that the random access resources corresponding to the MTC terminal are insufficient.

In this embodiment of the present disclosure, the operation of accepting, by the base station, the random access process that is initiated by the MTC terminal over the predefined random access resources may be receiving, by the base station, the preamble that is in the predefined preamble resources and that is sent by the MTC terminal over the TF-resource that is included in the TF-resource group in the random access resources corresponding to the coverage enhancement level of the MTC terminal, or receiving, by the base station, the predefined preamble that is in the preamble resources in the random access resources corresponding to the coverage enhancement level of the MTC terminal, and that is sent by the MTC terminal over the predefined TF-resource in the TF-resource group in the random access resources corresponding to the coverage enhancement level of the MTC terminal.

The operation of determining, by the base station according to the random access process that is initiated by the MTC terminal over the predefined random access resources, that the random access resources corresponding to the MTC terminal are insufficient may be determining, by the base station according to the predefined random access resources, that the random access resources corresponding to the coverage enhancement level of the MTC terminal are insufficient.

In this embodiment of the present disclosure, when the MTC terminal initiates, using the predefined random access resources, the random access process to notify the base station that the random access resources corresponding to the coverage enhancement level of the MTC terminal are insufficient, the base station may further determine, according to the random access process that is initiated by the MTC terminal over the predefined random access resources, that the random access resources corresponding to the coverage enhancement level of the MTC terminal are insufficient.

Further, the base station may further determine the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may be determining, by the base station according to the preamble that is in the predefined preamble resources and that is sent by the MTC terminal over the predefined TF-resource in the TF-resource group in the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the TF-resource that is included in the TF-resource group in the random access resources corresponding to the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may further be determining, by the base station according to the predefined preamble that is in the preamble resources in the random access resources corresponding to the coverage enhancement level of the MTC terminal, and that is sent by the MTC terminal over the predefined TF-resource in the TF-resource group in the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the predefined TF-resource in the TF-resource group in the random access resources corresponding to the coverage enhancement level of the MTC terminal and/or the predefined preamble in the preamble resources in the random access resources corresponding to the coverage enhancement level of the MTC terminal.

Step 408: The base station sends a response RAR message to the MTC terminal.

The response RAR message is used to notify the MTC terminal that the base station has received the random access process initiated by the MTC terminal.

Step 409: The MTC terminal receives the response RAR message sent by the base station, and sends a message 3 to the base station according to the response RAR message, where the message 3 carries coverage enhancement level information of the MTC terminal.

The coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the base station receives the message 3 sent by the MTC terminal, and determines the coverage enhancement level of the MTC terminal according to the coverage enhancement level information that is of the MTC terminal and carried in the message 3.

Step 410: The base station increases the random access resources corresponding to the coverage enhancement level of the MTC terminal.

The operation of increasing, by the base station, the random access resources corresponding to the coverage enhancement level of the MTC terminal may be acquiring, by the base station, a first predefined quantity of TF-resources from a TF-resource group in random access resources corresponding to a coverage enhancement level except the coverage enhancement level of the MTC terminal, and transferring the acquired first predefined quantity of TF-resources to the random access resources corresponding to the coverage enhancement level of the MTC terminal, where the first predefined quantity is less than or equal to a quantity of TF-resources that are included in the TF-resource group.

The operation of increasing, by the base station, the random access resources corresponding to the coverage enhancement level of the MTC terminal may further be acquiring, by the base station, a second predefined quantity of TF-resources from TF-resources in random access resources corresponding to a coverage enhancement level except the coverage enhancement level of the MTC terminal, and transferring the acquired second predefined quantity of TF-resources to the random access resources corresponding to the coverage enhancement level of the MTC terminal, where the second predefined quantity is less than or equal to a quantity of TF-resources that are included in the TF-resources.

The operation of increasing, by the base station, the random access resources corresponding to the coverage enhancement level of the MTC terminal may further be acquiring, by the base station, a third predefined quantity of TF-resources from TF-resources except random access resources corresponding to all coverage enhancement levels in the base station, and transferring the acquired third predefined quantity of TF-resources to the random access resources corresponding to the coverage enhancement level of the MTC terminal, where the third predefined quantity is less than or equal to a quantity of TF-resources that are included in the TF-resources except the random access resources corresponding to all the coverage enhancement levels in the base station.

The base station may randomly select a coverage enhancement level except the coverage enhancement level of the MTC terminal, and the base station may also determine, according to a historical record, a coverage enhancement level corresponding to sufficient random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 4

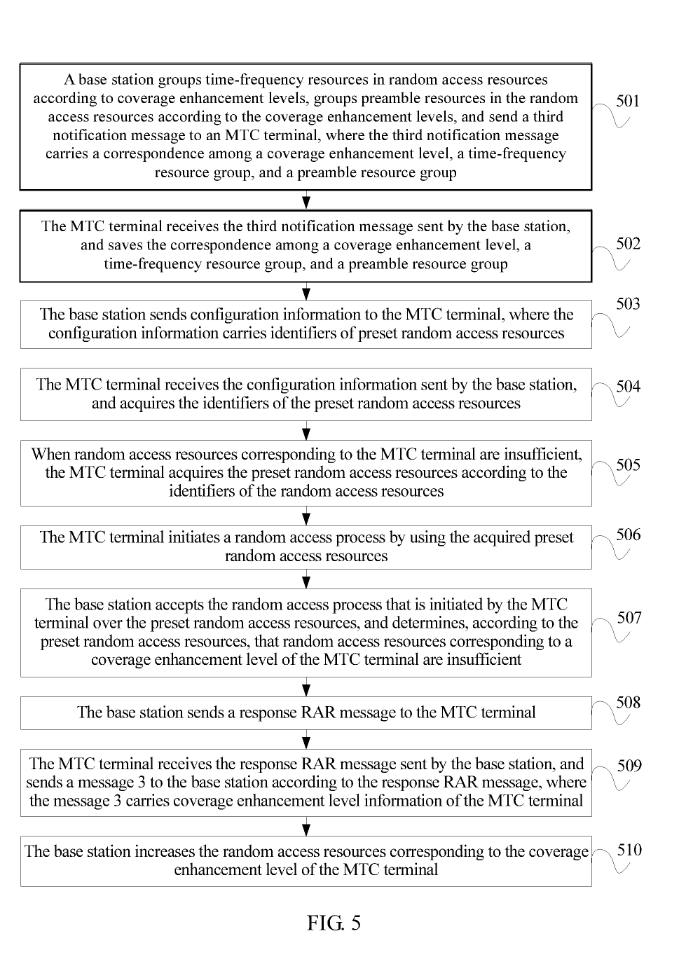

This embodiment of the present disclosure provides a method for randomly accessing a network. Grouping TF-resources and preamble resources in random access resources jointly is used as an example for description in this embodiment of the present disclosure. Referring to FIG. 5, the method includes the following steps:

Step 501: A base station groups TF-resources in random access resources according to coverage enhancement levels, groups preamble resources in the random access resources according to the coverage enhancement levels, and sends a third notification message to an MTC terminal, where the third notification message carries a correspondence among a coverage enhancement level, a TF-resource group, and a preamble resource group.

The random access resources include a TF-resource and a preamble resource. The coverage enhancement level refers to a level of degree to which coverage needs to be enhanced when the MTC terminal communicates with the base station, and different coverage enhancement levels are corresponding to different coverage enhancement technologies or different combinations of coverage enhancement technologies. The MTC terminal is any MTC terminal for which the base station provides a service.

The base station allocates the TF-resources in the random access resources to each coverage enhancement level according to the coverage enhancement levels, for example, allocates, in an even manner, the TF-resources evenly to each coverage enhancement level, allocates the preamble resources in the random access resources to each coverage enhancement level, for example, allocates, in an even manner, the preamble resources evenly to each coverage enhancement level, and sends the third notification message to all MTC terminals for which the base station provides a service, where the third notification message carries the correspondence among a coverage enhancement level, a TF-resource group, and a preamble resource group.

Step 502: The MTC terminal receives the third notification message sent by the base station, and saves the correspondence among a coverage enhancement level, a TF-resource group, and a preamble resource group.

The MTC terminal saves the correspondence among a coverage enhancement level, a TF-resource group, and a preamble resource group. When the MTC terminal randomly accesses a network, the MTC terminal determines a TF-resource group according to a coverage enhancement level, and acquires a TF-resource from the TF-resource group, and the MTC terminal determines a preamble resource group according to the coverage enhancement level, selects one preamble from the determined preamble resource group, and sends the acquired preamble to the base station over the acquired TF-resource, in order to randomly access the network.

Step 503: The base station sends configuration information to the MTC terminal, where the configuration information carries identifiers of predefined random access resources.

The configuration information may further carry a correspondence between an identifier of a predefined random access resource and a predefined period. When random access resources corresponding to the MTC terminal are insufficient, the MTC terminal may acquire a predefined period according to the configuration information, and acquire a predefined random access resource according to the predefined period.

The predefined random access resources are used such that the MTC terminal initiates, using the predefined random access resources, a random access process when random access resources corresponding to a coverage enhancement level of the MTC terminal are insufficient.

The predefined random access resources are further used to notify the base station that the random access resources corresponding to the coverage enhancement level of the MTC terminal are insufficient.

In this embodiment of the present disclosure, the predefined random access resources are a predefined TF-resource that is included in a TF-resource group in the random access resources corresponding to the coverage enhancement level of the MTC terminal, and a predefined preamble in a preamble resource group in the random access resources corresponding to the coverage enhancement level of the MTC terminal, or the predefined random access resources are a preamble except the random access resources corresponding to the coverage enhancement level of the MTC terminal, and a predefined TF-resource in a TF-resource group in the random access resources corresponding to the coverage enhancement level of the MTC terminal, or the predefined random access resources are a TF-resource except the random access resources corresponding to the coverage enhancement level of the MTC terminal, and a predefined preamble that is included in a preamble resource group in the random access resources corresponding to the coverage enhancement level of the MTC terminal, or the predefined random access resources are a predefined TF-resource except the random access resources corresponding to the coverage enhancement level of the MTC terminal, and a predefined preamble except the random access resources corresponding to the coverage enhancement level of the MTC terminal.

The predefined random access resources may appear periodically, for example, it is configured on the base station that a predefined TF-resource appears once every 5 s, or the predefined random access resources are configured by a system.

Step 504: The MTC terminal receives the configuration information sent by the base station, and acquires the identifiers of the predefined random access resources.

Step 505: When random access resources corresponding to the MTC terminal are insufficient, the MTC terminal acquires the predefined random access resources according to the identifiers of the predefined random access resources.

Before the MTC terminal acquires the predefined random access resources when the random access resources corresponding to the MTC terminal are insufficient, the MTC terminal determines the coverage enhancement level of the MTC terminal, acquires, according to the coverage enhancement level of the MTC terminal, the random access resources corresponding to the coverage enhancement level of the MTC terminal, and uses the random access resources corresponding to the coverage enhancement level of the MTC terminal, as the random access resources corresponding to the MTC terminal.

The operation of determining, by the MTC terminal, the coverage enhancement level of the MTC terminal may be determining, by the MTC terminal according to its own path loss, the coverage enhancement level of the MTC terminal.

Correspondingly, that the random access resources corresponding to the MTC terminal are insufficient may be that the random access resources corresponding to the coverage enhancement level of the MTC terminal are insufficient.

A method for detecting, by the MTC terminal, that the random access resources corresponding to the coverage enhancement level of the MTC terminal are insufficient may be: There is a relatively high probability that a conflict occurs in initiating a random access process by the MTC terminal.

The operation of detecting, by the MTC terminal, that there is a relatively high probability that a conflict occurs in initiating a random access process by the MTC terminal may be when the MTC terminal still fails to access a network after initiating the random access process for a predefined quantity of times, determining, by the MTC terminal, that there is a relatively high probability that a conflict occurs in initiating the random access process, that is, the random access resources corresponding to the coverage enhancement level of the MTC terminal are insufficient.

The predefined quantity of times is set and changed according to the coverage enhancement level of the MTC terminal. The predefined quantity of times is not further limited in the present disclosure.

The operation of acquiring, by the MTC terminal, the predefined random access resources according to the identifiers of the predefined random access resources may be acquiring, by the MTC terminal according to the identifiers of the predefined random access resources, the predefined TF-resource that is included in the TF-resource group in the random access resources corresponding to the coverage enhancement level of the MTC terminal, and the predefined preamble in the preamble resource group in the random access resources corresponding to the coverage enhancement level of the MTC terminal, or the operation of acquiring, by the MTC terminal, the predefined random access resources according to the identifiers of the predefined random access resources may be acquiring, by the MTC terminal according to the identifiers of the predefined random access resources, the preamble except the random access resources corresponding to the coverage enhancement level of the MTC terminal, and the predefined TF-resource in the TF-resource group in the random access resources corresponding to the coverage enhancement level of the MTC terminal, or the operation of acquiring, by the MTC terminal, the predefined random access resources according to the identifiers of the predefined random access resources may be acquiring, by the MTC terminal according to the identifiers of the predefined random access resources, a preamble that is included in the preamble resource group in the random access resources corresponding to the coverage enhancement level of the MTC terminal, and the TF-resource except the random access resources corresponding to the coverage enhancement level of the MTC terminal, or the operation of acquiring, by the MTC terminal, the predefined random access resources according to the identifiers of the predefined random access resources may be acquiring, by the MTC terminal according to the identifiers of the predefined random access resources, the predefined TF-resource except the random access resources corresponding to the coverage enhancement level of the MTC terminal, and the predefined preamble except the random access resources corresponding to the coverage enhancement level of the MTC terminal.

In this embodiment of the present disclosure, the MTC terminal may also receive, when the random access resources corresponding to the MTC terminal are insufficient, the configuration information sent by the base station, and acquire the identifiers of the predefined random access resources, which is not further limited in the present disclosure.

Step 506: The MTC terminal initiates a random access process using the acquired predefined random access resources.

The MTC terminal may initiate, using the predefined random access resources, the random access process and may further notify the base station that the random access resources corresponding to the coverage enhancement level of the MTC terminal are insufficient.

When the operation of acquiring, by the MTC terminal, the predefined random access resources according to the identifiers of the predefined random access resources is acquiring, by the MTC terminal, the predefined TF-resource that is included in the TF-resource group in the random access resources corresponding to the coverage enhancement level of the MTC terminal, and the predefined preamble in the preamble resource group in the random access resources corresponding to the coverage enhancement level of the MTC terminal, the operation of initiating, by the MTC terminal, the random access process using the acquired predefined random access resources is sending, by the MTC terminal, the acquired predefined preamble to the base station over the acquired predefined TF-resource, in order to initiate the random access process.

Further, the MTC terminal sends the acquired predefined preamble to the base station over the acquired predefined TF-resource, in order to notify the base station that the random access resources corresponding to the coverage enhancement level of the MTC terminal are insufficient.

When the operation of acquiring, by the MTC terminal, the predefined random access resources according to the identifiers of the predefined random access resources is acquiring, by the MTC terminal, the preamble that is included in the preamble resource group in the random access resources corresponding to the coverage enhancement level of the MTC terminal, and the predefined TF-resource in the TF-resource group in the random access resources corresponding to the coverage enhancement level of the MTC terminal, the operation of initiating, by the MTC terminal, the random access process using the acquired predefined random access resources is sending, by the MTC terminal, the acquired preamble to the base station over the acquired predefined TF-resource, in order to initiate the random access process.

Further, the MTC terminal sends the acquired preamble to the base station over the acquired predefined TF-resource, in order to notify the base station that the random access resources corresponding to the coverage enhancement level of the MTC terminal are insufficient.

When the operation of acquiring, by the MTC terminal, the predefined random access resources according to the identifiers of the predefined random access resources is acquiring, by the MTC terminal, the preamble except the random access resources corresponding to the coverage enhancement level of the MTC terminal, and the predefined TF-resource in the TF-resource group in the random access resources corresponding to the coverage enhancement level of the MTC terminal, the operation of initiating, by the MTC terminal, the random access process using the acquired predefined random access resources is sending, by the MTC terminal, the acquired preamble to the base station over the acquired predefined TF-resource, in order to initiate the random access process.

Further, the MTC terminal sends the acquired preamble to the base station over the acquired predefined TF-resource, in order to notify the base station that the random access resources corresponding to the coverage enhancement level of the MTC terminal are insufficient.

When the operation of acquiring, by the MTC terminal, the predefined random access resources according to the identifiers of the predefined random access resources is acquiring, by the MTC terminal, the predefined TF-resource except the random access resources corresponding to the coverage enhancement level of the MTC terminal, and the predefined preamble except the random access resources corresponding to the coverage enhancement level of the MTC terminal, the operation of initiating, by the MTC terminal, the random access process using the acquired predefined random access resources is sending, by the MTC terminal, the acquired predefined preamble to the base station over the acquired predefined TF-resource, in order to initiate the random access process.

Further, the MTC terminal sends the acquired predefined preamble to the base station over the acquired predefined TF-resource, in order to notify the base station that the random access resources corresponding to the coverage enhancement level of the MTC terminal are insufficient.

Step 507: The base station accepts the random access process that is initiated by the MTC terminal over the predefined random access resources, and determines, according to the predefined random access resources, that random access resources corresponding to a coverage enhancement level of the MTC terminal are insufficient.

The base station determines, according to the random access process that is initiated by the MTC terminal over the predefined random access resources, that the random access resources corresponding to the MTC terminal are insufficient.

In this embodiment of the present disclosure, the operation of accepting, by the base station, the random access process that is initiated by the MTC terminal over the predefined random access resources may be receiving, by the base station, the predefined preamble that is in the preamble resource group and that is sent by the MTC terminal over the predefined TF-resource in the TF-resource group in the random access resources corresponding to the coverage enhancement level of the MTC terminal, or receiving, by the base station, the preamble, except the random access resources corresponding to the coverage enhancement level of the MTC terminal, that is sent by the MTC terminal over the predefined TF-resource in the TF-resource group in the random access resources corresponding to the coverage enhancement level of the MTC terminal, or receiving, by the base station, the predefined preamble that is included in the preamble resource group in the random access resources corresponding to the coverage enhancement level of the MTC terminal, and that is sent by the MTC terminal over the TF-resource except the random access resources corresponding to the coverage enhancement level of the MTC terminal, or receiving, by the base station, the predefined preamble, except the random access resources corresponding to the coverage enhancement level of the MTC terminal, that is sent by the MTC terminal over the predefined TF-resource except the random access resources corresponding to the coverage enhancement level of the MTC terminal.

The operation of determining, by the base station according to the random access process that is initiated by the MTC terminal over the predefined random access resources, that the random access resources corresponding to the MTC terminal are insufficient may be determining, by the base station according to the predefined random access resources, that the random access resources corresponding to the coverage enhancement level of the MTC terminal are insufficient, and determining the coverage enhancement level of the MTC terminal.

In this embodiment of the present disclosure, when the MTC terminal initiates, using the predefined random access resources, the random access process to notify the base station that the random access resources corresponding to the coverage enhancement level of the MTC terminal are insufficient, the base station may further determine, according to the random access process that is initiated by the MTC terminal over the predefined random access resources, that the random access resources corresponding to the coverage enhancement level of the MTC terminal are insufficient, and determine the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may be determining, by the base station according to the predefined preamble that is in the preamble resource group and that is sent by the MTC terminal over the predefined TF-resource in the TF-resource group in the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the predefined TF-resource in the TF-resource group in the random access resources corresponding to the coverage enhancement level of the MTC terminal, and the predefined preamble in the preamble resource group in the random access resources corresponding to the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may further be determining, by the base station according to the preamble, except the random access resources corresponding to the coverage enhancement level of the MTC terminal, that is sent by the MTC terminal over the predefined TF-resource in the TF-resource group in the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the predefined TF-resource in the TF-resource group in the random access resources corresponding to the coverage enhancement level of the MTC terminal, and the preamble in the preamble resource group in the random access resources corresponding to the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may further be determining, by the base station according to the preamble that is in the preamble resource group in the random access resources corresponding to the coverage enhancement level of the MTC terminal, and that is sent by the MTC terminal over the TF-resource except the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the preamble in the preamble resource group in the random access resources corresponding to the coverage enhancement level of the MTC terminal.

The operation of further determining, by the base station according to the random access process that is initiated by the MTC terminal over the predefined random access resources, that the random access resources corresponding to the coverage enhancement level of the MTC terminal are insufficient may further be: determining, by the base station according to the predefined preamble, except the random access resources corresponding to the coverage enhancement level of the MTC terminal, that is sent by the MTC terminal over the predefined TF-resource except the random access resources corresponding to the coverage enhancement level of the MTC terminal, that the random access resources corresponding to the coverage enhancement level of the MTC terminal are insufficient.

Further, the base station determines the coverage enhancement level of the MTC terminal according to the predefined TF-resource and/or the predefined preamble.

Step 508: The base station sends a response RAR message to the MTC terminal.

The response RAR message is used to notify the MTC terminal that the base station has received the random access process initiated by the MTC terminal.

Step 509: The MTC terminal receives the response RAR message sent by the base station, and sends a message 3 to the base station according to the response RAR message, where the message 3 carries coverage enhancement level information of the MTC terminal.

The coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the base station receives the message 3 sent by the MTC terminal, and determines the coverage enhancement level of the MTC terminal according to the coverage enhancement level information that is of the MTC terminal and carried in the message 3.

Step 510: The base station increases the random access resources corresponding to the coverage enhancement level of the MTC terminal.

The operation of increasing, by the base station, the random access resources corresponding to the coverage enhancement level of the MTC terminal may be, acquiring, by the base station, a seventh predefined quantity of TF-resources and an eighth predefined quantity of preambles respectively from a TF-resource group and a preamble resource group that are in random access resources corresponding to a coverage enhancement level except the coverage enhancement level of the MTC terminal, and transferring the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group.

The operation of increasing, by the base station, the random access resources corresponding to the coverage enhancement level of the MTC terminal may further be, acquiring, by the base station, a ninth predefined quantity of TF-resources and a tenth predefined quantity of preambles respectively from TF-resources and preamble resources that are in random access resources corresponding to a coverage enhancement level except the coverage enhancement level of the MTC terminal, and transferring the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources.

The operation of increasing, by the base station, the random access resources corresponding to the coverage enhancement level of the MTC terminal may be acquiring, by the base station, an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transferring the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

The base station may randomly select a coverage enhancement level except the coverage enhancement level of the MTC terminal, and the base station may also determine, according to a historical record, a coverage enhancement level corresponding to sufficient random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 5

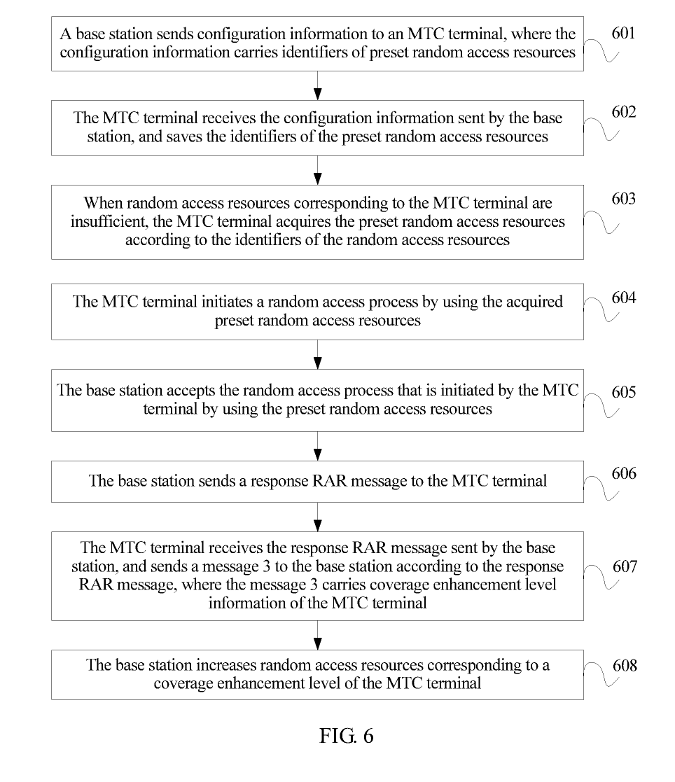

This embodiment of the present disclosure provides a method for randomly accessing a network. In this embodiment of the present disclosure, an example in which predefined random access resources are random access resources corresponding to a coverage enhancement level except a coverage enhancement level of an MTC terminal is used for description. Referring to FIG. 6, the method includes the following steps:

Step 601: A base station sends configuration information to an MTC terminal, where the configuration information carries identifiers of predefined random access resources.

The random access resources include a TF-resource and a preamble resource. A coverage enhancement level refers to a level of degree to which coverage needs to be enhanced when the MTC terminal communicates with the base station, and different coverage enhancement levels are corresponding to different coverage enhancement technologies or different combinations of coverage enhancement technologies. The MTC terminal is any MTC terminal for which the base station provides a service.

The configuration information may further carry a correspondence between an identifier of a predefined random access resource and a predefined period. When random access resources corresponding to the MTC terminal are insufficient, the MTC terminal may acquire a predefined period according to the configuration information, and acquire a predefined random access resource according to the predefined period.

In this embodiment of the present disclosure, the MTC terminal is a terminal that requires coverage enhancement. The predefined random access resources are random access resources corresponding to a coverage enhancement level except a coverage enhancement level of the MTC terminal, for example, random access resources corresponding to a coverage enhancement level that is higher than the coverage enhancement level of the MTC terminal. The configuration information may further carry a correspondence between a coverage enhancement level and a TF-resource and a preamble resource.

Different coverage enhancement levels are corresponding to different preamble resources and/or TF-resources, for example, when a coverage enhancement level is 0, corresponding preamble resources are a preamble 0 and a preamble 1, and corresponding TF-resources are TF-resources over which four preambles are sent or received at a time.

Step 602: The MTC terminal receives the configuration information sent by the base station, and saves the identifiers of the predefined random access resources.

The MTC terminal further saves the correspondence between a coverage enhancement level and a TF-resource and a preamble resource. When the MTC terminal randomly accesses a network, the MTC terminal determines a TF-resource and a preamble resource according to the coverage enhancement level of the MTC terminal.

Before the MTC terminal determines the TF-resource according to the coverage enhancement level of the MTC terminal, the MTC terminal determines the coverage enhancement level of the MTC terminal according to its own path loss.

Step 603: When random access resources corresponding to the MTC terminal are insufficient, the MTC terminal acquires the predefined random access resources according to the identifiers of the predefined random access resources.

Before the MTC terminal acquires the predefined random access resources when the random access resources corresponding to the MTC terminal are insufficient, the MTC terminal determines the coverage enhancement level of the MTC terminal, acquires, according to the coverage enhancement level of the MTC terminal, random access resources corresponding to the coverage enhancement level of the MTC terminal, and uses the random access resources corresponding to the coverage enhancement level of the MTC terminal, as the random access resources corresponding to the MTC terminal.

Correspondingly, that the random access resources corresponding to the MTC terminal are insufficient may be that the random access resources corresponding to the coverage enhancement level of the MTC terminal are insufficient.

A method for detecting, by the MTC terminal, that the random access resources corresponding to the coverage enhancement level of the MTC terminal are insufficient may be: There is a relatively high probability that a conflict occurs in initiating a random access process by the MTC terminal.

The operation of detecting, by the MTC terminal, that there is a relatively high probability that a conflict occurs in initiating a random access process by the MTC terminal may be when the MTC terminal still fails to access a network after initiating the random access process for a predefined quantity of times, determining, by the MTC terminal, that there is a relatively high probability that a conflict occurs in initiating the random access process, that is, the random access resources corresponding to the coverage enhancement level of the MTC terminal are insufficient.

The predefined quantity of times may be set and changed by the base station according to the coverage enhancement level of the MTC terminal. The predefined quantity of times is not further limited in the present disclosure.

The operation of acquiring, by the MTC terminal, the predefined random access resources according to the identifiers of the predefined random access resources may be acquiring, by the MTC terminal according to the identifiers of the predefined random access resources, the coverage enhancement level except the coverage enhancement level of the MTC terminal, and acquiring the predefined random access resources according to the acquired coverage enhancement level except the coverage enhancement level of the MTC terminal.

The acquiring the predefined random access resources according to the coverage enhancement level except the coverage enhancement level of the MTC terminal may be acquiring, by the MTC terminal, a TF-resource and a preamble that are in random access resources corresponding to the coverage enhancement level except the coverage enhancement level of the MTC terminal.

The acquiring the predefined random access resources according to the coverage enhancement level except the coverage enhancement level of the MTC terminal may further be acquiring, by the MTC terminal, a TF-resource in random access resources corresponding to the coverage enhancement level except the coverage enhancement level of the MTC terminal, and acquiring, by the MTC terminal, a preamble in the preamble resources in the random access resources corresponding to the coverage enhancement level of the MTC terminal.

The acquiring the predefined random access resources according to the coverage enhancement level except the coverage enhancement level of the MTC terminal may further be acquiring, by the MTC terminal, a preamble resource in random access resources corresponding to the coverage enhancement level except the coverage enhancement level of the MTC terminal, and acquiring, by the MTC terminal, a TF-resource in the TF-resources in the random access resources corresponding to the coverage enhancement level of the MTC terminal.

The acquiring the predefined random access resources according to the coverage enhancement level except the coverage enhancement level of the MTC terminal may be acquiring, by the MTC terminal, a TF-resource in random access resources corresponding to the coverage enhancement level except the coverage enhancement level of the MTC terminal, and acquiring, by the MTC terminal, a preamble that is included in a preamble resource group in the random access resources corresponding to the coverage enhancement level of the MTC terminal.

Step 604: The MTC terminal initiates a random access process using the acquired predefined random access resources.

Furthermore, the MTC terminal sends an acquired preamble to the base station over an acquired TF-resource, in order to initiate the random access process.

The operation of initiating, by the MTC terminal, the random access process using the acquired predefined random access resources may further be sending, by the MTC terminal, the preamble in the random access resources corresponding to the coverage enhancement level except the coverage enhancement level of the MTC terminal, to the base station over the TF-resource in the random access resources corresponding to the coverage enhancement level except the coverage enhancement level of the MTC terminal, in order to initiate the random access process.

The operation of initiating, by the MTC terminal, the random access process using the acquired predefined random access resources may further be sending, by the MTC terminal, the preamble in the preamble resources in the random access resources corresponding to the coverage enhancement level of the MTC terminal, to the base station over the TF-resource in the random access resources corresponding to the coverage enhancement level except the coverage enhancement level of the MTC terminal, in order to initiate the random access process.

The operation of initiating, by the MTC terminal, the random access process using the acquired predefined random access resources may further be sending, by the MTC terminal, the preamble resource in the random access resources corresponding to the coverage enhancement level except the coverage enhancement level of the MTC terminal, to the base station over the TF-resource in the TF-resources in the random access resources corresponding to the coverage enhancement level of the MTC terminal, so as to initiate the random access process.

The operation of initiating, by the MTC terminal, the random access process using the acquired predefined random access resources may further be sending, by the MTC terminal, the preamble that is included in the preamble resource group in the random access resources corresponding to the coverage enhancement level of the MTC terminal, to the base station over the TF-resource in the random access resources corresponding to the coverage enhancement level except the coverage enhancement level of the MTC terminal, in order to initiate the random access process.

The operation of initiating, by the MTC terminal, the random access process using the acquired predefined random access resources may further be acquiring, by the MTC terminal according to the coverage enhancement level of the MTC terminal and/or the coverage enhancement level except the coverage enhancement level of the MTC terminal, power at which the MTC terminal sends a preamble, and sending the acquired preamble to the base station over the acquired TF-resource at the acquired power for sending the preamble, in order to initiate the random access process.

The MTC terminal may initiate, using the acquired predefined random access resources, the random access process and may further notify the base station that the random access resources corresponding to the coverage enhancement level of the MTC terminal are insufficient.

The MTC terminal sends the acquired preamble to the base station over the acquired TF-resource, in order to notify the base station that the random access resources corresponding to the coverage enhancement level of the MTC terminal are insufficient.

Step 605: The base station accepts the random access process that is initiated by the MTC terminal using the predefined random access resources.

The base station determines, according to the random access process that is initiated by the MTC terminal over the predefined random access resources, that the random access resources corresponding to the MTC terminal are insufficient.

In this embodiment of the present disclosure, the operation of accepting, by the base station, the random access process that is initiated by the MTC terminal over the predefined random access resources may be receiving, by the base station, a preamble that is sent by the MTC terminal over an acquired TF-resource.

The operation of receiving, by the base station, the preamble that is sent by the MTC terminal over the acquired TF-resource may be receiving, by the base station, the preamble that is in the random access resources corresponding to the coverage enhancement level except the coverage enhancement level of the MTC terminal, and that is sent by the MTC terminal over the TF-resource in the random access resources corresponding to the coverage enhancement level except the coverage enhancement level of the MTC terminal.

Further, the base station determines, according to the preamble that is in the random access resources corresponding to the coverage enhancement level except the coverage enhancement level of the MTC terminal, and that is sent by the MTC terminal over the TF-resource in the random access resources corresponding to the coverage enhancement level except the coverage enhancement level of the MTC terminal, that the random access resources corresponding to the coverage enhancement level of the MTC terminal are insufficient.

The operation of receiving, by the base station, the preamble that is sent by the MTC terminal over the acquired TF-resource may further be receiving, by the base station, the preamble that is in the preamble resources in the random access resources corresponding to the coverage enhancement level of the MTC terminal, and that is sent by the MTC terminal over the TF-resource in the random access resources corresponding to the coverage enhancement level except the coverage enhancement level of the MTC terminal.

Further, the base station determines, according to the preamble that is in the preamble resources in the random access resources corresponding to the coverage enhancement level of the MTC terminal, and that is sent by the MTC terminal over the TF-resource in the random access resources corresponding to the coverage enhancement level except the coverage enhancement level of the MTC terminal, that the random access resources corresponding to the coverage enhancement level of the MTC terminal are insufficient.

The operation of receiving, by the base station, the preamble that is sent by the MTC terminal over the acquired TF-resource may further be receiving, by the base station, the preamble resource that is in the random access resources corresponding to the coverage enhancement level except the coverage enhancement level of the MTC terminal, and that is sent by the MTC terminal over the TF-resource in the TF-resources in the random access resources corresponding to the coverage enhancement level of the MTC terminal.

Further, the base station determines, according to the preamble resource that is in the random access resources corresponding to the coverage enhancement level except the coverage enhancement level of the MTC terminal, and that is sent by the MTC terminal over the TF-resource in the TF-resources in the random access resources corresponding to the coverage enhancement level of the MTC terminal, that the random access resources corresponding to the coverage enhancement level of the MTC terminal are insufficient.

The operation of receiving, by the base station, the preamble that is sent by the MTC terminal over the acquired TF-resource may further be receiving, by the base station, the preamble that is included in the preamble resource group in the random access resources corresponding to the coverage enhancement level of the MTC terminal, and that is sent by the MTC terminal over the TF-resource in the random access resources corresponding to the coverage enhancement level except the coverage enhancement level of the MTC terminal.

Further, the base station determines, according to the preamble that is included in the preamble resource group in the random access resources corresponding to the coverage enhancement level of the MTC terminal, and that is sent by the MTC terminal over the TF-resource in the random access resources corresponding to the coverage enhancement level except the coverage enhancement level of the MTC terminal, that the random access resources corresponding to the coverage enhancement level of the MTC terminal are insufficient.

Step 606: The base station sends a response RAR message to the MTC terminal.

The response RAR message is used to notify the MTC terminal that the base station has received the random access process initiated by the MTC terminal.

Step 607: The MTC terminal receives the response RAR message sent by the base station, and sends a message 3 to the base station according to the response RAR message, where the message 3 carries coverage enhancement level information of the MTC terminal.

The coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the base station receives the message 3 sent by the MTC terminal, and determines the coverage enhancement level of the MTC terminal according to the coverage enhancement level information that is of the MTC terminal and carried in the message 3.

Step 608: The base station increases random access resources corresponding to a coverage enhancement level of the MTC terminal.

The operation of increasing, by the base station, the random access resources corresponding to the coverage enhancement level of the MTC terminal may be acquiring, by the base station, a seventh predefined quantity of TF-resources and an eighth predefined quantity of preambles respectively from a TF-resource group and a preamble resource group that are in the random access resources corresponding to the coverage enhancement level except the coverage enhancement level of the MTC terminal, and transferring the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group.

The operation of increasing, by the base station, the random access resources corresponding to the coverage enhancement level of the MTC terminal may further be acquiring, by the base station, a ninth predefined quantity of TF-resources and a tenth predefined quantity of preambles respectively from the TF-resources and the preamble resources that are in the random access resources corresponding to the coverage enhancement level except the coverage enhancement level of the MTC terminal, and transferring the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources.

The operation of increasing, by the base station, the random access resources corresponding to the coverage enhancement level of the MTC terminal may be acquiring, by the base station, an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transferring the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

The base station may randomly select a coverage enhancement level except the coverage enhancement level of the MTC terminal, and the base station may also determine, according to a historical record, a coverage enhancement level corresponding to sufficient random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 6

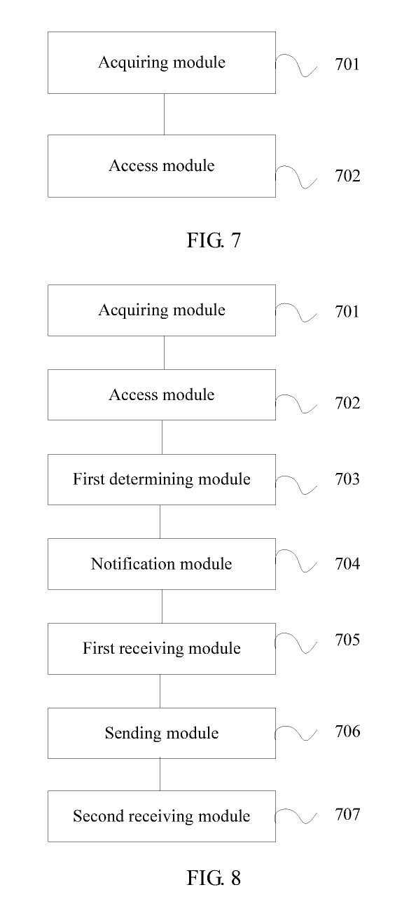

This embodiment of the present disclosure provides a schematic apparatus diagram of a structure of a terminal. Referring to FIG. 7, the terminal includes an acquiring module 701 configured to acquire predefined random access resources when random access resources corresponding to a MTC terminal are insufficient, where the predefined random access resources are random access resources corresponding to the MTC terminal, or the predefined random access resources are random access resources except random access resources corresponding to the MTC terminal, and an access module 702 configured to initiate a random access process using the acquired predefined random access resources.

Further, this embodiment of the present disclosure provides another schematic apparatus diagram of a structure of a terminal. Referring to FIG. 8, the terminal includes an acquiring module 701 and an access module 702, and the terminal further includes a first determining module 703 configured to determine a coverage enhancement level of the MTC terminal, where the acquiring module 701 is further configured to acquire, according to the coverage enhancement level of the MTC terminal, random access resources corresponding to the coverage enhancement level of the MTC terminal, and use the random access resources corresponding to the coverage enhancement level of the MTC terminal, as the random access resources corresponding to the MTC terminal.

Further, the random access resources include a TF-resource and a preamble resource, and correspondingly, the acquiring module 701 is configured to acquire a TF-resource in predefined TF-resources and a preamble that is included in a preamble resource group in the random access resources corresponding to the coverage enhancement level of the MTC terminal.

Further, the access module 702 is configured to send the acquired preamble to a base station using the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a predefined TF-resource in the TF-resources in the random access resources corresponding to the coverage enhancement level of the MTC terminal, and acquire a predefined preamble that is included in a preamble resource group in the random access resources corresponding to the coverage enhancement level of the MTC terminal.

Further, the access module 702 is configured to send the acquired predefined preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a preamble in predefined preamble resources and a TF-resource that is included in a TF-resource group in the random access resources corresponding to the coverage enhancement level of the MTC terminal.

Further, the access module 702 is configured to send the acquired preamble in the predefined preamble resources to a base station over the acquired TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a predefined preamble in the preamble resources in the random access resources corresponding to the coverage enhancement level of the MTC terminal, and acquire a predefined TF-resource that is included in a TF-resource group in the random access resources corresponding to the coverage enhancement level of the MTC terminal.

Further, the access module 702 is configured to send the acquired predefined preamble in the preamble resources corresponding to the MTC terminal to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a predefined TF-resource that is included in a TF-resource group in the random access resources corresponding to the coverage enhancement level of the MTC terminal, and a predefined preamble that is included in a preamble resource group in the random access resources corresponding to the coverage enhancement level of the MTC terminal.

Further, the access module 702 is configured to send the acquired predefined preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a preamble except the random access resources corresponding to the coverage enhancement level of the MTC terminal, and a predefined TF-resource that is included in a TF-resource group in the random access resources corresponding to the coverage enhancement level of the MTC terminal.

Further, the access module 702 is configured to send the acquired preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a TF-resource except the random access resources corresponding to the coverage enhancement level of the MTC terminal, and a predefined preamble that is included in a preamble resource group in the random access resources corresponding to the coverage enhancement level of the MTC terminal.

Further, the access module 702 is configured to send the acquired predefined preamble to a base station over the acquired TF-resource, in order to notify the base station that the random access resources corresponding to the coverage enhancement level of the MTC terminal are insufficient.

Further, the random access resources include a TF-resource and a preamble resource, and correspondingly, the acquiring module 701 is configured to acquire a predefined TF-resource except the random access resources corresponding to the coverage enhancement level of the MTC terminal, and a predefined preamble except the random access resources corresponding to the coverage enhancement level of the MTC terminal.

Further, the access module 702 is configured to send the acquired predefined preamble to a base station over the acquired predefined TF-resource, in order to notify the base station that the random access resources corresponding to the coverage enhancement level of the MTC terminal are insufficient.

Further, the acquiring module 701 is configured to acquire a coverage enhancement level except the coverage enhancement level of the MTC terminal, and acquire the predefined random access resources according to the acquired coverage enhancement level except the coverage enhancement level of the MTC terminal.

Further, the random access resources include a TF-resource and a preamble resource, and correspondingly, the acquiring module 701 is configured to acquire a TF-resource and a preamble that are in random access resources corresponding to the coverage enhancement level except the coverage enhancement level of the MTC terminal.

Further, the access module 702 is configured to send the preamble in the random access resources corresponding to the coverage enhancement level except the coverage enhancement level of the MTC terminal, to a base station over the TF-resource in the random access resources corresponding to the coverage enhancement level except the coverage enhancement level of the MTC terminal, in order to initiate the random access process.

Further, the random access resources include a TF-resource and a preamble resource and correspondingly, the acquiring module 701 is configured to acquire a TF-resource in random access resources corresponding to the coverage enhancement level except the coverage enhancement level of the MTC terminal and acquire a preamble in the preamble resources in the random access resources corresponding to the coverage enhancement level of the MTC terminal.

Further, the access module 702 is configured to send the preamble in the preamble resources in the random access resources corresponding to the coverage enhancement level of the MTC terminal, to a base station over the TF-resource in the random access resources corresponding to the coverage enhancement level except the coverage enhancement level of the MTC terminal, in order to initiate the random access process.

Further, the random access resources include a TF-resource and a preamble resource, and correspondingly, the acquiring module is configured to acquire a preamble resource in random access resources corresponding to the coverage enhancement level except the coverage enhancement level of the MTC terminal, and acquire a TF-resource in the TF-resources in the random access resources corresponding to the coverage enhancement level of the MTC terminal.

Further, the access module 702 is configured to send the preamble resource in the random access resources corresponding to the coverage enhancement level except the coverage enhancement level of the MTC terminal, to a base station over the TF-resource in the TF-resources in the random access resources corresponding to the coverage enhancement level of the MTC terminal, in order to initiate the random access process.

Further, the random access resources include a TF-resource and a preamble resource, and correspondingly, the acquiring module 701 is configured to acquire a TF-resource in random access resources corresponding to the coverage enhancement level except the coverage enhancement level of the MTC terminal, and acquire a preamble that is included in a preamble resource group in the random access resources corresponding to the coverage enhancement level of the MTC terminal.

Further, the access module 702 is configured to send the preamble to a base station over the acquired TF-resource, in order to initiate the random access process.

Further, the terminal further includes a notification module 704 configured to notify the base station that the random access resources corresponding to the coverage enhancement level of the MTC terminal are insufficient.

Further, the random access resources include a TF-resource and a preamble resource, and correspondingly, the access module 702 is configured to acquire, according to the coverage enhancement level of the MTC terminal and/or the coverage enhancement level except the coverage enhancement level of the MTC terminal, power at which the MTC terminal sends a preamble, and send the acquired preamble to a base station over the acquired TF-resource at the acquired power for sending the preamble, in order to initiate the random access process.

Further, the terminal further includes a first receiving module 705 configured to receive a response RAR message sent by a base station, and a sending module 706 configured to send a random access process message 3 to the base station according to the RAR message, where the random access process message 3 carries coverage enhancement level information of the MTC terminal.

Further, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the terminal further includes a second receiving module 707 configured to receive configuration information sent by a base station, where the configuration information carries identifiers of the predefined random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 7

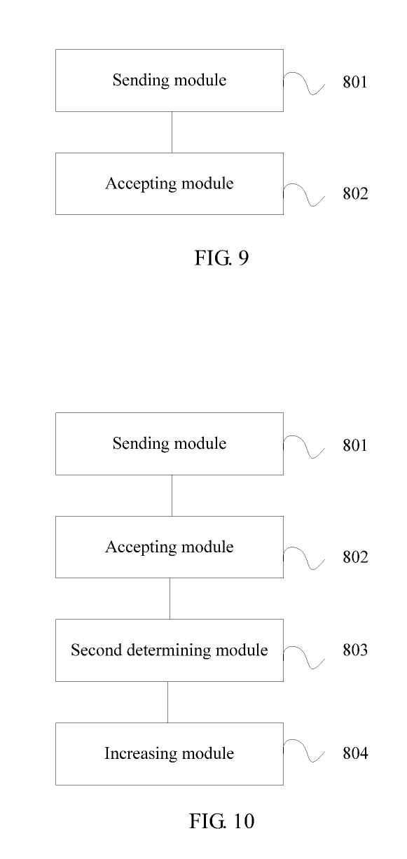

This embodiment of the present disclosure provides a schematic apparatus diagram of a structure of a base station. Referring to FIG. 9, the base station includes a sending module 801 configured to send configuration information to an MTC terminal, where the configuration information carries identifiers of predefined random access resources, such that the MTC terminal acquires the predefined random access resources according to the configuration information, and an accepting module 802 configured to accept a random access process that is initiated by the MTC terminal using the acquired predefined random access resources.

Further, this embodiment of the present disclosure provides another schematic apparatus diagram of a structure of a base station. Referring to FIG. 10, the base station includes the sending module 801 and the accepting module 802, and the apparatus further includes the accepting module 802 is further configured to determine, according to the random access process that is initiated by the MTC terminal over the predefined random access resources, that random access resources corresponding to the MTC terminal are insufficient.

Further, the MTC terminal is a terminal that requires coverage enhancement, and correspondingly, the accepting module 802 is configured to determine, according to the predefined random access resources, that random access resources corresponding to a coverage enhancement level of the MTC terminal are insufficient.

Further, the MTC terminal is a terminal that requires coverage enhancement, and correspondingly, the accepting module 802 is configured to send a response RAR message to the MTC terminal, such that the MTC terminal sends a message 3 to the base station according to the RAR message, and receive the message 3 sent by the MTC terminal, where the message 3 carries coverage enhancement level information of the MTC terminal.

Further, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, the base station further includes a second determining module 803 configured to determine the coverage enhancement level of the MTC terminal.

Further, the second determining module 803 is configured to determine the coverage enhancement level of the MTC terminal according to the predefined random access resources and/or the message 3.

Further, the base station further includes an increasing module 804 configured to increase the random access resources corresponding to the coverage enhancement level of the MTC terminal.

Further, the random access resources include a TF-resource and a preamble resource and correspondingly, the increasing module 804 is configured to acquire a first predefined quantity of TF-resources from a TF-resource group in random access resources corresponding to a coverage enhancement level except the coverage enhancement level of the MTC terminal, or acquire a second predefined quantity of TF-resources from TF-resources in random access resources corresponding to a coverage enhancement level except the coverage enhancement level of the MTC terminal, or acquire a third predefined quantity of TF-resources from TF-resources except random access resources corresponding to all coverage enhancement levels in the base station, and transfer the acquired first predefined quantity of TF-resources, or the acquired second predefined quantity of TF-resources, or the acquired third predefined quantity of TF-resources to the random access resources corresponding to the coverage enhancement level of the MTC terminal, where the first predefined quantity is less than or equal to a quantity of TF-resources that are included in the TF-resource group, the second predefined quantity is less than or equal to a quantity of TF-resources that are included in the TF-resources, and the third predefined quantity is less than or equal to a quantity of TF-resources that are included in the TF-resources except the random access resources corresponding to all the coverage enhancement levels in the base station.

Further, the random access resources include a TF-resource and a preamble resource and correspondingly, the increasing module 804 is configured to acquire a fourth predefined quantity of preambles from a preamble resource group in random access resources corresponding to a coverage enhancement level except the coverage enhancement level of the MTC terminal, or acquire a fifth predefined quantity of preambles from preamble resources in random access resources corresponding to a coverage enhancement level except the coverage enhancement level of the MTC terminal, or acquire a sixth predefined quantity of preambles from preamble resources except random access resources corresponding to all coverage enhancement levels in the base station, and transfer the acquired fourth predefined quantity of preambles, or the acquired fifth predefined quantity of preambles, or the acquired sixth predefined quantity of preambles to the random access resources corresponding to the coverage enhancement level of the MTC terminal, where the fourth predefined quantity is less than or equal to a quantity of preambles that are included in the preamble resource group, the fifth predefined quantity is less than or equal to a quantity of preambles that are included in the preamble resources, and the sixth predefined quantity is less than or equal to a quantity of preambles that are included in the preamble resources except the random access resources corresponding to all the coverage enhancement levels in the base station.

Further, the random access resources include a TF-resource and a preamble resource, and correspondingly, the increasing module 804 is configured to acquire a seventh predefined quantity of TF-resources and an eighth predefined quantity of preambles respectively from a TF-resource group and a preamble resource group that are in random access resources corresponding to a coverage enhancement level except the coverage enhancement level of the MTC terminal, and transfer the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group, or the increasing module 804 is configured to acquire a ninth predefined quantity of TF-resources and a tenth predefined quantity of preambles respectively from TF-resources and preamble resources that are in random access resources corresponding to a coverage enhancement level except the coverage enhancement level of the MTC terminal, and transfer the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources, or the increasing module 804 is configured to acquire an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transfer the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

Further, the accepting module 802 is configured to receive a preamble that is included in a preamble resource group in the random access resources corresponding to the coverage enhancement level of the MTC terminal and that is sent by the MTC terminal over a TF-resource in predefined TF-resources, and determine that the random access resources corresponding to the coverage enhancement level of the MTC terminal are insufficient.

Further, the accepting module 802 is configured to receive a predefined preamble that is included in a preamble resource group in the random access resources corresponding to the coverage enhancement level of the MTC terminal, and that is sent by the MTC terminal over a predefined TF-resource in TF-resources in the random access resources corresponding to the coverage enhancement level of the MTC terminal, and determine that the random access resources corresponding to the coverage enhancement level of the MTC terminal are insufficient.

Further, the accepting module 802 is configured to receive a preamble that is in predefined preamble resources and is sent by the MTC terminal over a TF-resource that is included in a TF-resource group in the random access resources corresponding to the coverage enhancement level of the MTC terminal, and determine that the random access resources corresponding to the coverage enhancement level of the MTC terminal are insufficient.

Further, the accepting module 802 is configured to receive a predefined preamble that is in preamble resources in the random access resources corresponding to the coverage enhancement level of the MTC terminal, and that is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

Further, the accepting module 802 is configured to receive a predefined preamble that is included in a preamble resource group and is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

Further, the accepting module 802 is configured to receive a preamble, except the random access resources corresponding to the coverage enhancement level of the MTC terminal, that is sent by the MTC terminal over a predefined TF-resource that is included in a TF-resource group in the random access resources corresponding to the coverage enhancement level of the MTC terminal, and determine that the random access resources corresponding to the coverage enhancement level of the MTC terminal are insufficient.

Further, the accepting module 802 is configured to receive a predefined preamble that is included in a preamble resource group in the random access resources corresponding to the coverage enhancement level of the MTC terminal, and that is sent by the MTC terminal over a TF-resource except the random access resources corresponding to the coverage enhancement level of the MTC terminal, and determine that the random access resources corresponding to the coverage enhancement level of the MTC terminal are insufficient.

Further, the accepting module 802 is configured to receive a predefined preamble, except the random access resources corresponding to the coverage enhancement level of the MTC terminal, that is sent by the MTC terminal over a predefined TF-resource except the random access resources corresponding to the coverage enhancement level of the MTC terminal, and determine that the random access resources corresponding to the coverage enhancement level of the MTC terminal are insufficient.

Further, the accepting module 802 is configured to receive a preamble that is in random access resources corresponding to a coverage enhancement level except the coverage enhancement level of the MTC terminal, and that is sent by the MTC terminal over a TF-resource in the random access resources corresponding to the coverage enhancement level except the coverage enhancement level of the MTC terminal, and determine that the random access resources corresponding to the coverage enhancement level of the MTC terminal are insufficient.

Further, the accepting module 802 is configured to receive a preamble resource that is in random access resources corresponding to a coverage enhancement level except the coverage enhancement level of the MTC terminal, and that is sent by the MTC terminal over a TF-resource in TF-resources in the random access resources corresponding to the coverage enhancement level of the MTC terminal, and determine that the random access resources corresponding to the coverage enhancement level of the MTC terminal are insufficient.

Further, the accepting module 802 is configured to receive a preamble that is included in a preamble resource group in the random access resources corresponding to the coverage enhancement level of the MTC terminal, and that is sent by the MTC terminal over a TF-resource in random access resources corresponding to a coverage enhancement level except the coverage enhancement level of the MTC terminal, and determine that the random access resources corresponding to the coverage enhancement level of the MTC terminal are insufficient.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

### Embodiment 8

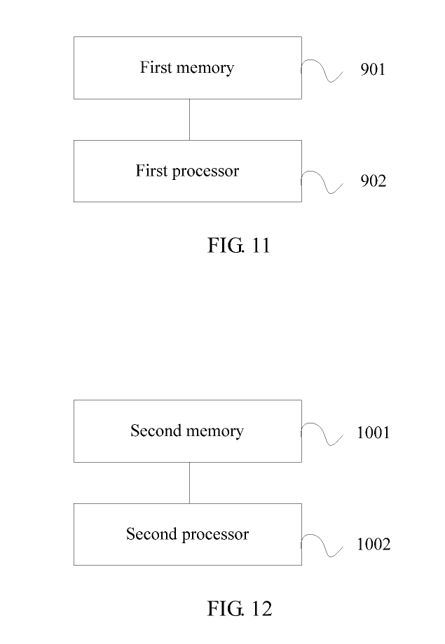

This embodiment of the present disclosure provides a schematic apparatus diagram of a structure of a terminal. Referring to FIG. 11, the terminal includes a first memory 901 and a first processor 902, which are configured to execute the following method for randomly accessing a network acquiring, by a MTC terminal, predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and initiating, by the MTC terminal, a random access process using the acquired predefined random access resources.

Further, the MTC terminal is a terminal that requires coverage enhancement, and before the acquiring, by a MTC terminal, predefined random access resources when random access resources corresponding to the MTC terminal are insufficient, the method further includes determining, by the MTC terminal, a coverage enhancement level of the MTC terminal, acquiring, according to the coverage enhancement level of the MTC terminal, random access resources corresponding to the coverage enhancement level of the MTC terminal, and using the random access resources corresponding to the coverage enhancement level of the MTC terminal, as the random access resources corresponding to the MTC terminal.

Further, the random access resources include a TF-resource and a preamble resource, and correspondingly, the acquiring predefined random access resources includes acquiring a TF-resource in predefined TF-resources and a preamble that is included in a preamble resource group in the random access resources corresponding to the coverage enhancement level of the MTC terminal.

Further, the initiating, by the MTC terminal, a random access process using the acquired predefined random access resources includes sending, by the MTC terminal, the acquired preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring, by the MTC terminal, a predefined TF-resource in the TF-resources in the random access resources corresponding to the coverage enhancement level of the MTC terminal, and acquiring a predefined preamble that is included in a preamble resource group in the random access resources corresponding to the coverage enhancement level of the MTC terminal.

Further, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a preamble in predefined preamble resources and a TF-resource that is included in a TF-resource group in the random access resources corresponding to the coverage enhancement level of the MTC terminal.

Further, the initiating, by the MTC terminal, a random access process using the acquired predefined random access resources includes sending, by the MTC terminal, the acquired preamble in the predefined preamble resources to a base station over the acquired TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a predefined preamble in the preamble resources in the random access resources corresponding to the coverage enhancement level of the MTC terminal, and acquiring a predefined TF-resource that is included in a TF-resource group in the random access resources corresponding to the coverage enhancement level of the MTC terminal.

Further, the initiating, by the MTC terminal, a random access process using the acquired predefined random access resources includes sending, by the MTC terminal, the acquired predefined preamble in the preamble resources corresponding to the MTC terminal to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a predefined TF-resource that is included in a TF-resource group in the random access resources corresponding to the coverage enhancement level of the MTC terminal, and a predefined preamble that is included in a preamble resource group in the random access resources corresponding to the coverage enhancement level of the MTC terminal.

Further, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a preamble except the random access resources corresponding to the coverage enhancement level of the MTC terminal, and a predefined TF-resource that is included in a TF-resource group in the random access resources corresponding to the coverage enhancement level of the MTC terminal.

Further, the initiating, by the MTC terminal, a random access process using the acquired predefined random access resources includes sending, by the MTC terminal, the acquired preamble to a base station over the acquired predefined TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a TF-resource except the random access resources corresponding to the coverage enhancement level of the MTC terminal, and a predefined preamble that is included in a preamble resource group in the random access resources corresponding to the coverage enhancement level of the MTC terminal.

Further, the initiating, by the MTC terminal, a random access process using the acquired predefined random access resources includes sending, by the MTC terminal, the acquired predefined preamble to a base station over the acquired TF-resource, in order to notify the base station that the random access resources corresponding to the coverage enhancement level of the MTC terminal are insufficient.

Further, the random access resources include a TF-resource and a preamble resource, and correspondingly, the acquiring predefined random access resources includes acquiring a predefined TF-resource except the random access resources corresponding to the coverage enhancement level of the MTC terminal, and a predefined preamble except the random access resources corresponding to the coverage enhancement level of the MTC terminal.

Further, the initiating, by the MTC terminal, a random access process using the acquired predefined random access resources includes sending, by the MTC terminal, the acquired predefined preamble to a base station over the acquired predefined TF-resource, in order to notify the base station that the random access resources corresponding to the coverage enhancement level of the MTC terminal are insufficient.

Further, the acquiring predefined random access resources includes acquiring, by the MTC terminal, a coverage enhancement level except the coverage enhancement level of the MTC terminal, and acquiring the predefined random access resources according to the acquired coverage enhancement level except the coverage enhancement level of the MTC terminal.

Further, the random access resources include a TF-resource and a preamble resource, and correspondingly, the acquiring the predefined random access resources according to the acquired coverage enhancement level except the coverage enhancement level of the MTC terminal includes acquiring, by the MTC terminal, a TF-resource and a preamble that are in random access resources corresponding to the coverage enhancement level except the coverage enhancement level of the MTC terminal.

Further, the initiating, by the MTC terminal, a random access process using the acquired predefined random access resources includes sending, by the MTC terminal, the preamble in the random access resources corresponding to the coverage enhancement level except the coverage enhancement level of the MTC terminal, to a base station over the TF-resource in the random access resources corresponding to the coverage enhancement level except the coverage enhancement level of the MTC terminal, in order to initiate the random access process.

Further, the random access resources include a TF-resource and a preamble resource, and correspondingly, the acquiring the predefined random access resources according to the coverage enhancement level except the coverage enhancement level of the MTC terminal includes acquiring, by the MTC terminal, a TF-resource in random access resources corresponding to the coverage enhancement level except the coverage enhancement level of the MTC terminal, and acquiring, by the MTC terminal, a preamble in the preamble resources in the random access resources corresponding to the coverage enhancement level of the MTC terminal.

Further, the initiating, by the MTC terminal, a random access process using the acquired predefined random access resources includes sending the preamble in the preamble resources in the random access resources corresponding to the coverage enhancement level of the MTC terminal, to a base station over the TF-resource in the random access resources corresponding to the coverage enhancement level except the coverage enhancement level of the MTC terminal, in order to initiate the random access process.

Further, the random access resources include a TF-resource and a preamble resource, and correspondingly, the acquiring the predefined random access resources according to the coverage enhancement level except the coverage enhancement level of the MTC terminal includes acquiring, by the MTC terminal, a preamble resource in random access resources corresponding to the coverage enhancement level except the coverage enhancement level of the MTC terminal, and acquiring, by the MTC terminal, a TF-resource in the TF-resources in the random access resources corresponding to the coverage enhancement level of the MTC terminal.

Further, the initiating, by the MTC terminal, a random access process using the acquired predefined random access resources includes sending the preamble resource in the random access resources corresponding to the coverage enhancement level except the coverage enhancement level of the MTC terminal, to a base station over the TF-resource in the TF-resources in the random access resources corresponding to the coverage enhancement level of the MTC terminal, in order to initiate the random access process.

Further, the random access resources include a TF-resource and a preamble resource, and correspondingly, the acquiring the predefined random access resources according to the coverage enhancement level except the coverage enhancement level of the MTC terminal includes acquiring, by the MTC terminal, a TF-resource in random access resources corresponding to the coverage enhancement level except the coverage enhancement level of the MTC terminal, and acquiring, by the MTC terminal, a preamble that is included in a preamble resource group in the random access resources corresponding to the coverage enhancement level of the MTC terminal.

Further, the initiating, by the MTC terminal, a random access process using the acquired predefined random access resources includes sending the preamble to a base station over the acquired TF-resource, in order to initiate the random access process.

Further, the method further includes notifying the base station that the random access resources corresponding to the coverage enhancement level of the MTC terminal are insufficient.

Further, the random access resources include a TF-resource and a preamble resource and correspondingly, the initiating, by the MTC terminal, a random access process using the acquired predefined random access resources includes acquiring, by the MTC terminal according to the coverage enhancement level of the MTC terminal and/or the coverage enhancement level except the coverage enhancement level of the MTC terminal, power at which the MTC terminal sends a preamble, and sending the acquired preamble to a base station over the acquired TF-resource at the acquired power for sending the preamble, so as to initiate the random access process.

Further, after the initiating, by the MTC terminal, a random access process using the acquired predefined random access resources, the method further includes receiving, by the MTC terminal, a response RAR message sent by a base station, and sending a random access process message 3 to the base station according to the RAR message, where the random access process message 3 carries coverage enhancement level information of the MTC terminal.

Further, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

Further, before the acquiring, by the MTC terminal, the predefined random access resources, the method further includes receiving configuration information sent by a base station, where the configuration information carries identifiers of the predefined random access resources.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, so as to provide a better service for the MTC terminal.

### Embodiment 9

This embodiment of the present disclosure provides a schematic apparatus diagram of a structure of a base station. Referring to FIG. 12, the base station includes: a second memory 1001 and a second processor 1002, which are configured to execute the following method for randomly accessing a network sending, by the base station, configuration information to an MTC terminal, where the configuration information carries identifiers of predefined random access resources, such that the MTC terminal acquires the predefined random access resources according to the configuration information, and accepting, by the base station, a random access process that is initiated by the MTC terminal using the acquired predefined random access resources.

Further, the accepting, by the base station, a random access process that is initiated by the MTC terminal using the acquired predefined random access resources includes determining, by the base station according to the random access process that is initiated by the MTC terminal over the predefined random access resources, that random access resources corresponding to the MTC terminal are insufficient.

Further, the MTC terminal is a terminal that requires coverage enhancement, and correspondingly, the determining, by the base station according to the random access process that is initiated by the MTC terminal over the predefined random access resources, that random access resources corresponding to the MTC terminal are insufficient includes determining, by the base station according to the predefined random access resources, that random access resources corresponding to a coverage enhancement level of the MTC terminal are insufficient.

Further, the MTC terminal is a terminal that requires coverage enhancement, and correspondingly, the accepting, by the base station, a random access process that is initiated by the MTC terminal using the acquired predefined random access resources includes sending, by the base station, a response RAR message to the MTC terminal, such that the MTC terminal sends a message 3 to the base station according to the RAR message, and receiving the message 3 sent by the MTC terminal, where the message 3 carries coverage enhancement level information of the MTC terminal.

Further, the coverage enhancement level information includes a coverage enhancement level required value of the MTC terminal, or the coverage enhancement level information includes a difference between a coverage enhancement level required value of the MTC terminal and a coverage enhancement level value corresponding to random access resources used by the MTC terminal to initiate the random access process, or a difference between a coverage enhancement level value corresponding to random access resources used by the MTC terminal to initiate the random access process and a coverage enhancement level required value of the MTC terminal.

The method further includes determining, by the base station, the coverage enhancement level of the MTC terminal.

Further, the determining, by the base station, the coverage enhancement level of the MTC terminal includes determining, by the base station according to the predefined random access resources and/or the message 3, the coverage enhancement level of the MTC terminal.

Further, after the determining, by the base station according to the predefined random access resources, that the random access resources corresponding to the coverage enhancement level of the MTC terminal are insufficient, and determining the coverage enhancement level of the MTC terminal, the method further includes increasing, by the base station, the random access resources corresponding to the coverage enhancement level of the MTC terminal.

Further, the random access resources include a TF-resource and a preamble resource, and correspondingly, the increasing, by the base station, the random access resources corresponding to the coverage enhancement level of the MTC terminal includes acquiring a first predefined quantity of TF-resources from a TF-resource group in random access resources corresponding to a coverage enhancement level except the coverage enhancement level of the MTC terminal, or acquiring a second predefined quantity of TF-resources from TF-resources in random access resources corresponding to a coverage enhancement level except the coverage enhancement level of the MTC terminal or acquiring a third predefined quantity of TF-resources from TF-resources except random access resources corresponding to all coverage enhancement levels in the base station, and transferring the acquired first predefined quantity of TF-resources, or the acquired second predefined quantity of TF-resources, or the acquired third predefined quantity of TF-resources to the random access resources corresponding to the coverage enhancement level of the MTC terminal, where the first predefined quantity is less than or equal to a quantity of TF-resources that are included in the TF-resource group, the second predefined quantity is less than or equal to a quantity of TF-resources that are included in the TF-resources, and the third predefined quantity is less than or equal to a quantity of TF-resources that are included in the TF-resources except the random access resources corresponding to all the coverage enhancement levels in the base station.

Further, the random access resources include a TF-resource and a preamble resource, and correspondingly, the increasing, by the base station, the random access resources corresponding to the coverage enhancement level of the MTC terminal includes: acquiring a fourth predefined quantity of preambles from a preamble resource group in random access resources corresponding to a coverage enhancement level except the coverage enhancement level of the MTC terminal, or acquiring a fifth predefined quantity of preambles from preamble resources in random access resources corresponding to a coverage enhancement level except the coverage enhancement level of the MTC terminal, or acquiring a sixth predefined quantity of preambles from preamble resources except random access resources corresponding to all coverage enhancement levels in the base station, and transferring the acquired fourth predefined quantity of preambles, or the acquired fifth predefined quantity of preambles, or the acquired sixth predefined quantity of preambles to the random access resources corresponding to the coverage enhancement level of the MTC terminal, where the fourth predefined quantity is less than or equal to a quantity of preambles that are included in the preamble resource group, the fifth predefined quantity is less than or equal to a quantity of preambles that are included in the preamble resources, and the sixth predefined quantity is less than or equal to a quantity of preambles that are included in the preamble resources except the random access resources corresponding to all the coverage enhancement levels in the base station.

Further, the random access resources include a TF-resource and a preamble resource, and correspondingly, the increasing, by the base station, the random access resources corresponding to the coverage enhancement level of the MTC terminal includes acquiring a seventh predefined quantity of TF-resources and an eighth predefined quantity of preambles respectively from a TF-resource group and a preamble resource group that are in random access resources corresponding to a coverage enhancement level except the coverage enhancement level of the MTC terminal, and transferring the acquired seventh predefined quantity of TF-resources and the acquired eighth predefined quantity of preambles to the random access resources corresponding to the coverage enhancement level of the MTC terminal, where the seventh predefined quantity is less than or equal to a quantity of TF-resources that are included in the TF-resource group, and the eighth predefined quantity is less than or equal to a quantity of preambles that are included in the preamble resource group, or acquiring a ninth predefined quantity of TF-resources and a tenth predefined quantity of preambles respectively from TF-resources and preamble resources that are in random access resources corresponding to a coverage enhancement level except the coverage enhancement level of the MTC terminal, and transferring the acquired ninth predefined quantity of TF-resources and the acquired tenth predefined quantity of preambles to the random access resources corresponding to the coverage enhancement level of the MTC terminal, where the ninth predefined quantity is less than or equal to a quantity of TF-resources that are included in the TF-resources, and the tenth predefined quantity is less than or equal to a quantity of preambles that are included in the preamble resources, or acquiring an eleventh predefined quantity of TF-resources and a twelfth predefined quantity of preambles respectively from TF-resources except random access resources corresponding to all coverage enhancement levels in the base station and preamble resources except the random access resources corresponding to all the coverage enhancement levels in the base station, and transferring the acquired eleventh predefined quantity of TF-resources and the acquired twelfth predefined quantity of preambles to the random access resources corresponding to the coverage enhancement level of the MTC terminal, where the eleventh predefined quantity is less than or equal to a quantity of TF-resources that are included in the TF-resources except the random access resources corresponding to all the coverage enhancement levels in the base station, and the twelfth predefined quantity is less than or equal to a quantity of preambles that are included in the preamble resources except the random access resources corresponding to all the coverage enhancement levels in the base station.

Further, the determining, by the base station according to the predefined random access resources, that the random access resources corresponding to the coverage enhancement level of the MTC terminal are insufficient includes receiving, by the base station, a preamble that is included in a preamble resource group in the random access resources corresponding to the coverage enhancement level of the MTC terminal and that is sent by the MTC terminal over a TF-resource in predefined TF-resources, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a predefined preamble that is included in a preamble resource group in the random access resources corresponding to the coverage enhancement level of the MTC terminal, and that is sent by the MTC terminal over a predefined TF-resource in TF-resources in the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a preamble that is in predefined preamble resources and is sent by the MTC terminal over a TF-resource that is included in a TF-resource group in the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a predefined preamble that is in preamble resources in the random access resources corresponding to the coverage enhancement level of the MTC terminal, and that is sent by the MTC terminal over a predefined TF-resource that is included in a TF-resource group in the random access resources corresponding to the coverage enhancement level of the MTC terminal; and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a predefined preamble that is included in a preamble resource group and is sent by the MTC terminal over a predefined TF-resource that is included in a TF-resource group in the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a preamble, except the random access resources corresponding to the coverage enhancement level of the MTC terminal, that is sent by the MTC terminal over a predefined TF-resource that is included in a TF-resource group in the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a predefined preamble that is included in a preamble resource group in the random access resources corresponding to the coverage enhancement level of the MTC terminal, and that is sent by the MTC terminal over a TF-resource except the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a predefined preamble, except the random access resources corresponding to the coverage enhancement level of the MTC terminal, that is sent by the MTC terminal over a predefined TF-resource except the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a preamble that is in random access resources corresponding to a coverage enhancement level except the coverage enhancement level of the MTC terminal, and that is sent by the MTC terminal over a TF-resource in the random access resources corresponding to the coverage enhancement level except the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a preamble resource that is in random access resources corresponding to a coverage enhancement level except the coverage enhancement level of the MTC terminal, and that is sent by the MTC terminal over a TF-resource in TF-resources in the random access resources corresponding to the coverage enhancement level of the MTC terminal, and determining that the random access resources corresponding to the coverage enhancement level of the MTC terminal are insufficient.

Further, the determining, by the base station according to the predefined random access resources, that the random access resources corresponding to the coverage enhancement level of the MTC terminal are insufficient includes receiving, by the base station, a preamble that is included in a preamble resource group in the random access resources corresponding to the coverage enhancement level of the MTC terminal, and that is sent by the MTC terminal over a TF-resource in random access resources corresponding to a coverage enhancement level except the coverage enhancement level of the MTC terminal, and determining that the random access resources corresponding to the coverage enhancement level of the MTC terminal are insufficient.

In this embodiment of the present disclosure, an MTC terminal acquires predefined random access resources when random access resources corresponding to the MTC terminal are insufficient, where the predefined random access resources are random access resources corresponding to the MTC terminal, or the predefined random access resources are random access resources except random access resources corresponding to the MTC terminal, and the MTC terminal initiates a random access process by using the acquired predefined random access resources. Therefore, a probability that a conflict occurs in randomly accessing a network is reduced, and random access resource utilization is improved. Further, the MTC terminal notifies a base station that random access resources corresponding to a coverage enhancement level of the MTC terminal are insufficient, and the base station increases the random access resources corresponding to the coverage enhancement level of the MTC terminal, in order to provide a better service for the MTC terminal.

It should be noted that, when the terminal provided in the foregoing embodiments randomly accesses a network, division of the foregoing functional modules is used as an example for description. In actual application, the foregoing functions can be allocated to different functional modules and implemented according to a requirement, that is, an inner structure of the terminal is divided into different functional modules to implement all or some of the functions described above. In addition, the terminal provided in the foregoing embodiments pertains to a same concept as the embodiments of the method for randomly accessing a network. For a specific implementation process of the terminal, reference may be made to the method embodiments, and details are not described herein again.

A person of ordinary skill in the art may understand that all or some of the steps of the embodiments may be implemented by hardware or a program instructing related hardware. The program may be stored in a computer-readable storage medium. The storage medium may include a read-only memory, a magnetic disk, an optical disc, or the like.

The foregoing descriptions are merely exemplary embodiments of the present disclosure, but are not intended to limit the present disclosure. Any modification, equivalent replacement, and improvement made without departing from the spirit and principle of the present disclosure shall fall within the protection scope of the present disclosure.

What is claimed is:

1. A method for randomly accessing a network, comprising:
acquiring, by a machine type communication (MTC) terminal, predefined random access resources when random access resources corresponding to the MTC terminal are insufficient, wherein the predefined random access resources are random access resources corresponding to the MTC terminal or the predefined random access resources are random access resources except random access resources corresponding to the MTC terminal; and
initiating, by the MTC terminal, a random access process using the acquired predefined random access resources.

2. The method according to claim 1, wherein the MTC terminal is a terminal that requires coverage enhancement, wherein before acquiring, by the MTC terminal, the predefined random access resources when random access resources corresponding to the MTC terminal are insufficient, the method further comprises:
determining, by the MTC terminal, a coverage enhancement level of the MTC terminal;
acquiring, according to the coverage enhancement level of the MTC terminal, random access resources corresponding to the coverage enhancement level of the MTC terminal; and
using the random access resources corresponding to the coverage enhancement level of the MTC terminal, as the random access resources corresponding to the MTC terminal.

3. The method according to claim 2, wherein acquiring the predefined random access resources comprises:
acquiring, by the MTC terminal, another coverage enhancement level except the coverage enhancement level of the MTC terminal; and
acquiring the predefined random access resources according to the acquired coverage enhancement level except the coverage enhancement level of the MTC terminal.

4. The method according to claim 2, wherein after initiating, by the MTC terminal, the random access process using the acquired predefined random access resources, the method further comprises:
receiving, by the MTC terminal, a random access response (RAR) message sent by a base station; and
sending a random access process message 3 to the base station according to the RAR message, and wherein the random access process message 3 carries coverage enhancement level information of the MTC terminal.

5. The method according to claim 1, wherein before acquiring, by the MTC terminal, predefined random access resources, the method further comprises receiving configuration information sent by the base station, and wherein the configuration information carries identifiers of the predefined random access resources.

6. A method for randomly accessing a network, comprising:
sending, by a base station, configuration information to a machine type communication (MTC) terminal, wherein the configuration information carries identifiers of predefined random access resources, such that the MTC terminal acquires the predefined random access resources according to the configuration information; and
accepting, by the base station, a random access process that is initiated by the MTC terminal using the acquired predefined random access resources.

7. The method according to claim 6, wherein accepting, by the base station, the random access process that is initiated by the MTC terminal using the acquired predefined random access resources comprises determining, by the base station according to the random access process that is initiated by the MTC terminal over the predefined random access resources, random access resources that corresponding to the MTC terminal are insufficient.

8. The method according to claim 7, wherein the MTC terminal is a terminal that requires coverage enhancement, wherein determining, by the base station according to the random access process that is initiated by the MTC terminal over the predefined random access resources, random access resources that corresponding to the MTC terminal are insufficient comprises determining, by the base station according to the predefined random access resources, that random access resources corresponding to a coverage enhancement level of the MTC terminal are insufficient.

9. The method according to claim 8, further comprising determining, by the base station, the coverage enhancement level of the MTC terminal.

10. The method according to claim 9, wherein determining, by the base station according to the predefined random access resources, random access resources that corresponding to the coverage enhancement level of the MTC terminal are insufficient comprises:
receiving, by the base station, a preamble that is in random access resources corresponding to another coverage enhancement level except the coverage enhancement level of the MTC terminal, and that is sent by the MTC terminal over a time frequency resource (TF-resource) in the random access resources corresponding to the coverage enhancement level except the coverage enhancement level of the MTC terminal; and
determining that the random access resources corresponding to the coverage enhancement level of the MTC terminal are insufficient.

11. A terminal, comprising:
a memory; and
a processor coupled to the memory, wherein the processor is configured to:
acquire predefined random access resources when random access resources corresponding to a machine type communication (MTC) terminal are insufficient, wherein the predefined random access resources are random access resources corresponding to the MTC terminal or the predefined random access resources are random access resources except random access resources corresponding to the MTC terminal; and
initiate a random access process using the acquired predefined random access resources.

12. The terminal according to claim 11, wherein the processor is further configured to:
determine a coverage enhancement level of the MTC terminal;
acquire, according to the coverage enhancement level of the MTC terminal, random access resources corresponding to the coverage enhancement level of the MTC terminal; and
use the random access resources corresponding to the coverage enhancement level of the MTC terminal, as the random access resources corresponding to the MTC terminal.

13. The terminal according to claim 12, wherein the processor is further configured to:
acquire another coverage enhancement level except the coverage enhancement level of the MTC terminal; and
acquire the predefined random access resources according to the acquired coverage enhancement level except the coverage enhancement level of the MTC terminal.

14. The terminal according to claim 12, further comprising:
a receiver coupled to the processor and configured to receive a random access response (RAR) message sent by a base station; and
a transmitter coupled to the processor and configured to send a random access process message 3 to the base station according to the RAR message, and wherein the random access process message 3 carries coverage enhancement level information of the MTC terminal.

15. The terminal according to claim 11, wherein the receiver is further configured to receive configuration information sent by the base station, and wherein the configuration information carries identifiers of the predefined random access resources.

16. A base station, comprising:
a transmitter configured to send configuration information to a machine type communication (MTC) terminal, wherein the configuration information carries identifiers of predefined random access resources, such that the MTC terminal acquires the predefined random access resources according to the configuration information; and
a receiver coupled to the transmitter and configured to accept a random access process that is initiated by the MTC terminal using the acquired predefined random access resources.

17. The base station according to claim 16, further comprising a processor coupled to the transmitter and the receiver and configured to determine, according to the random access process that is initiated by the MTC terminal over the predefined random access resources, random access resources that corresponding to the MTC terminal are insufficient.

18. The base station according to claim 17, wherein the MTC terminal is a terminal that requires coverage enhancement, and wherein the processor is further configured to determine, according to the predefined random access resources, random access resources that corresponding to a coverage enhancement level of the MTC terminal are insufficient.

19. The base station according to claim 18, wherein the processor is further configured to determine the coverage enhancement level of the MTC terminal.

20. The base station according to claim 19, wherein the receiver is further configured to receive a preamble that is in random access resources corresponding to another coverage enhancement level except the coverage enhancement level of the MTC terminal, and that is sent by the MTC terminal over a time frequency resource (TF-resource) in the random access resources corresponding to the coverage enhancement level except the coverage enhancement level of the MTC terminal, and wherein the processor is further configured to determine that the random access resources corresponding to the coverage enhancement level of the MTC terminal are insufficient.
